(19) United States
(12) Patent Application Publication
(10) Pub. No.: US 2026/0371066 A1
(43) Pub. Date: Nov. 19, 2026

(54) PROVIDING SUBSCRIPTION DATA OF AN EXTERNAL SUBSCRIBER

(71) Applicant: Lenovo (Singapore) Pte. Ltd., Singapore (SG)

(72) Inventors: Genadi Velev, Darmstadt (DE); Apostolis Salkintzis, Athens (GR); Sheeba Backia Mary Baskaran, Friedrichsdorf (DE)

(21) Appl. No.: 19/751,055

(22) Filed: Jul. 22, 2026

Related U.S. Application Data
(63) Continuation of application No. 17/999,653, filed on May 22, 2020, now Pat. No. 12,713,224.

(51) Int. Cl. H04W 8/20

(52) U.S. Cl. CPC H04W 8/20

(57) ABSTRACT

Various aspects of the present disclosure relate to receiving, from a user equipment (“UE”), a registration request message containing a UE identifier and determining an authentication server function (“AUSF”) based on a local configuration and the UE identifier. Further aspects include transmitting, to the AUSF, an authentication request message associated with the UE and receiving retrieval parameters in response to a successful authentication of the UE, where the retrieval parameters include a network address of an external provisioning server.

### FIELD

The subject matter disclosed herein relates generally to wireless communications and more particularly relates to providing subscription data for an external subscriber.

### BACKGROUND

A wireless communications system may include one or multiple network communication devices, which may be known as a network equipment (“NE”), supporting wireless communications for one or multiple user communication devices, which may be otherwise known as user equipment (“UE”), or other suitable terminology. The wireless communications system may support wireless communications with one or multiple user communication devices. Additionally, the wireless communications system may support wireless communications across various radio access technologies including fourth generation (“4G”) radio access technologies and fifth generation (“5G”) radio access technologies, among other suitable radio access technologies.

In certain implementations, non-public networks (“NPN”) are deployed to serve private (i.e., non-public) customers and/or service. A Standalone NPN (“SNPN”) can be operated by an NPN operator and does not rely on network functions provided by a Public Mobile Land Network (“PLMN”).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of””) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

An access and mobility management functions (“AMF”) wireless communication is described. The AMF may be configured to, capable of, or operable to cause the AMF to receive, from a UE, a registration request message containing a UE identifier; determine an Authentication Server Function (“AUSF”) based on a local configuration and the UE identifier; transmit, to the AUSF, an authentication request message associated with the UE; and receive retrieval parameters in response to a successful authentication of the UE, where the retrieval parameters include a network address of an external provisioning server.

A method performed or performable by an AMF is described. The method may include receiving, from a UE, a registration request message containing a UE identifier and determining an AUSF based on a local configuration and the UE identifier. Further aspects include transmitting, to the AUSF, an authentication request message associated with the UE and receiving retrieval parameters in response to a successful authentication of the UE, where the retrieval parameters include a network address of an external provisioning server.

### BRIEF DESCRIPTION OF THE DRAWINGS

A more particular description of the implementations briefly described above will be rendered by reference to specific implementations that are illustrated in the appended drawings. Understanding that these drawings depict only some implementations and are not therefore to be considered to be limiting of scope, the implementations will be described and explained with additional specificity and detail through the use of the accompanying drawings, in which:

FIG. 1 illustrates a wireless communication system for providing subscription data for an external subscriber, in accordance with aspects of the present disclosure.

FIG. 2 illustrates a network deployment for providing subscription data for an external subscriber, in accordance with aspects of the present disclosure.

FIG. 3A illustrates signaling flow for provisioning of external (group) subscription to Serving SNPN, in accordance with aspects of the present disclosure.

FIG. 3B is a continuation of the procedure depicted in FIG. 3A.

FIG. 4A illustrates signaling flow for on-demand provisioning of external subscription to Serving SNPN, in accordance with aspects of the present disclosure.

FIG. 4B is a continuation of the procedure depicted in FIG. 4A.

FIG. 4C is a continuation of the procedure depicted in FIGS. 4A-4B.

FIG. 5A illustrates signaling flow for dynamic provisioning of external subscription to Serving SNPN triggered from the Authentication, Authorization, and Accounting (“AAA”) server, in accordance with aspects of the present disclosure.

FIG. 5B is a continuation of the procedure depicted in FIG. 5A.

FIG. 5C is a continuation of the procedure depicted in FIGS. 5A-5B.

FIG. 6 illustrates a network equipment apparatus for providing subscription data for an external subscriber, in accordance with aspects of the present disclosure.

FIG. 7 illustrates a first method for providing subscription data for an external subscriber, in accordance with aspects of the present disclosure.

FIG. 8 illustrates a second method for providing subscription data for an external subscriber, in accordance with aspects of the present disclosure.

FIG. 9 illustrates a third method for providing subscription data for an external subscriber, in accordance with aspects of the present disclosure.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM”) or Flash memory, a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Furthermore, the described features, structures, or characteristics of the implementations may be combined in any suitable manner. In the following description, numerous specific details are provided, such as examples of programming, software modules, user selections, network transactions, database queries, database structures, hardware modules, hardware circuits, hardware chips, etc., to provide a thorough understanding of implementations. One skilled in the relevant art will recognize, however, that implementations may be practiced without one or more of the specific details, or with other methods, components, materials, and so forth. In other instances, well-known structures, materials, or operations are not shown or described in detail to avoid obscuring aspects of an implementation.

Aspects of the implementations are described below with reference to schematic flowchart diagrams and/or schematic block diagrams of methods, apparatuses, systems, and program products according to implementations. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products according to various implementations. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding figures. Like numbers refer to like elements in all figures, including alternate implementations of like elements.

Methods, apparatuses, and systems are disclosed for providing subscription data for an external subscriber. Non-public networks (“NPN”) are networks according to the 5G system (“5GS”) which are deployed to serve private (i.e., non-public) customers and/or service. An NPN can also offer a public service (public telephony service or emergency service), if the NPN has an agreement with a PLMN or an access to public switched telephone network (“PSTN”). An NPNs can be deployed in different ways, for example 1) either stand-alone (“SNPN”) or 2) public network integrated (“PNI-NPN”). The SNPNs can be operated by an NPN operator and not relying on network functions provided by a PLMN. In contrast, the PNI-NPNs are deployed via a public land mobile network (“PLMN”) by means of dedicated data network names (“DNNs”), or by one (or more) Network Slice instances allocated for the NPN. In case of PNI-NPN, the UE has a subscription for the PLMN. Usually a network customer can request the PLMN to setup a PNI-NPN to use specific customer service. The network customer is called “NPN customer” in this description.

The UE can have a default subscription for a network (e.g., PLMN) provisioned in the UE and in the network. With the default subscription, the UE may be able to register to the PLMN for some default services, but the UE would not be able to use the NPN customer services unless a service level agreement (“SLA”) is in place between the PLMN and NPN.

When a UE roams into a visited network, the UE subscription is retrieved from the network functions (NFs) in the visited network from the home network. In case of PLMNs which are part of the roaming interconnection (e.g., Internet Protocol exchange (“IPX”) infrastructure), the NFs (e.g., AMF, Session Management Function (“SMF”), etc.) contact the Unified Data Management (“UDM”) in the home PLMN to retrieve the UE's subscription data. However, in case of private networks like SNPNs, the roaming interconnection is not available. Therefore, the problem needs to be addressed of how to provide UE's subscription data to the Serving SNPN and the relevant NFs (e.g., AMF, SMF and Policy Control Function (“PCF”)).

In case the UE subscription owner does not support roaming interfaces and UDM/AUSF functionality, there is currently no solution specified for how to provide UE's subscription data to the visited network (e.g., SNPN) and the relevant NFs (e.g., AMF, SMF and PCF). The AMF cannot complete the Registration procedure without AM subscription data. The PCF also need to obtain the UE subscription from the Unified Data Repository (“UDR”) to derive the UE policy or configuration. After registration, during protocol data unit (“PDU”) Session establishment procedure, the AMF and SMF also need to corresponding access management and/or session management (“AM/SM”) subscription data in order to process the UE request.

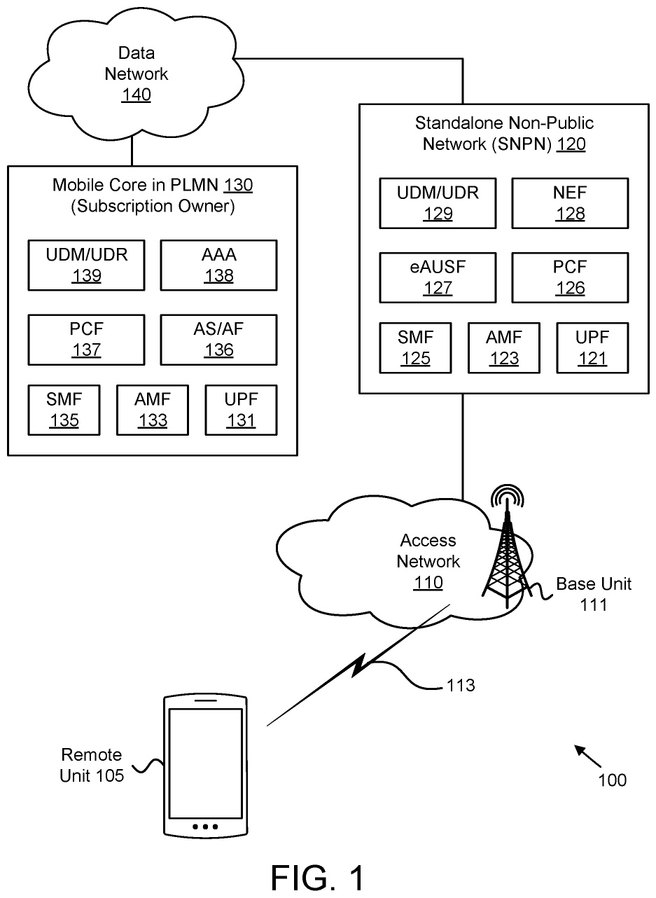

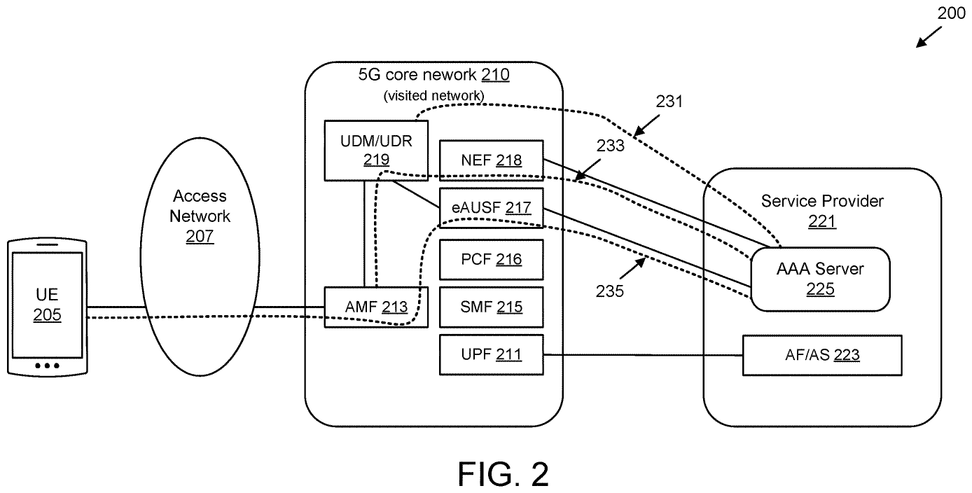

The architecture assumed for this solution is shown in FIGS. 1-2. The UE selects and initiates a registration with SNPN, whereas the UE's subscription data is stored in 3rd party Subscription Owner domain. Please note that in this document the Subscription Owner (“SO”) is also described as Service Provider (“SP”) and both terms may be used inter-changeably. The SO or SP is shown as PLMN in the left-hand side of the FIG. 1. It is however possible that the SP (which may be represented with the Application Server (“AS”) or Application Function (“AF”)) can be independent entity from the SO (which can be represented by the AAA infrastructure including AAA server). The AAA server (or other entities storing UE credentials) may also store the UE service subscription, i.e., the services (and descriptive information like type, bitrate, spending allowance, etc.) which are subscribed for the UE. This latter deployment case where the SO has AAA infrastructure (i.e., not PLMN nor SNPN) is shown in the right-hand side of the FIG. 2.

FIG. 1 depicts a wireless communication system 100 for registering with a mobile network through another mobile network, in accordance with aspects of the present disclosure. In one implementation, the wireless communication system 100 includes at least one remote unit 105, at least one access network 110 (each access network comprising at least one base unit 111), a standalone non-public network (“SNPN”) 120, and a mobile core network 130 in a PLMN. The access network 110 may be composed of at least one base unit 111. The remote unit 105 may communicate with the access network 110 using third generation partnership project (“3GPP”) communication links and/or non-3GPP communication links, according to a radio access technology deployed by the access network 110. Even though a specific number of remote units 105, access networks 110, base units 111, SNPN 120 and mobile core networks 130 are depicted in FIG. 1, one of skill in the art will recognize that any number of remote units 105, access networks 110, base units 111, SNPN 120, and mobile core networks 130 may be included in the wireless communication system 100.

In one implementation, the wireless communication system 100 is compliant with the 5G system specified in the 3GPP specifications. More generally, however, the wireless communication system 100 may implement some other open or proprietary communication network, for example, LTE/EPC (referred as 4G) or WiMAX, among other networks. The present disclosure is not intended to be limited to the implementation of any particular wireless communication system architecture or protocol.

In one implementation, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some implementations, the remote units 105 include wearable devices, such as smart watches, fitness bands, optical head-mounted displays, or the like. Moreover, the remote unit 105 may be referred to as UE, subscriber unit, mobile, mobile station, user, terminal, mobile terminal, fixed terminal, subscriber station, user terminal, wireless transmit/receive unit (“WTRU”), a device, or by other terminology used in the art.

The remote units 105 may communicate directly with one or more of the base units 111 in the access network 110 via uplink (“UL”) and downlink (“DL”) communication signals. Furthermore, the UL and DL communication signals may be carried over the communication links 113. Note, that the access network 110 is an intermediate network that provide the remote units 105 with access to the SNPN 120 and/or mobile core network 130.

In some implementations, the remote units 105 communicate with an application server (or other communication peer) via a network connection with the SNPN 120 and/or mobile core network 130. For example, an application in a remote unit 105 (e.g., web browser, media client, telephone (e.g., voice-over-internet-protocol (“VoIP”)) application) may trigger the remote unit 105 to establish a PDU session (or other data connection) with the SNPN 120 using the access network 110. The SNPN 120 then relays traffic between the remote unit 105 and the, e.g., application server (in the data network 140) using the PDU session. Note that the remote unit 105 may establish one or more PDU sessions (or other data connections) with the SNPN 120. As such, the remote unit 105 may have at least one PDU session for communicating with the data network 140. The remote unit 105 may establish additional PDU sessions for communicating with other data network and/or other communication peers.

As discussed in further detail below, a signaling connection of a remote unit 105 with the SNPN 120 may be used to register the remote unit 105 with the SNPN 120. Specifically, a remote unit 105 having a subscription (or other account) with the mobile core network 130 may register with the SNPN 120 using the signaling connection in order to use a service in the SNPN 120, as described in further detail below. In the depicted implementation, the SNPN 120 is a visited network for the remote unit 105 and the mobile core network 130 is a home network for the remote unit 105.

The base units 111 may be distributed over a geographic region. In certain implementations, a base unit 111 may also be referred to as an access terminal, an access point, a base, a base station, a Node-B, an eNB, a gNB, a Home Node-B, a relay node, a device, or by any other terminology used in the art. The base units 111 are generally part of a radio access network (“RAN”), such as the access network 110, that may include one or more controllers communicably coupled to one or more corresponding base units 111. These and other elements of radio access network are not illustrated but are well known generally by those having ordinary skill in the art. The base units 111 connect to the SNPN 120 and mobile core network 130 via the access network 110.

The base units 111 may serve a number of remote units 105 within a serving area, for example, a cell or a cell sector, via a communication link 113. The base units 111 may communicate directly with one or more of the remote units 105 via communication signals. Generally, the base units 111 transmit DL communication signals to serve the remote units 105 in the time, frequency, and/or spatial domain. Furthermore, the DL communication signals may be carried over the communication links 113. The communication links 113 may be any suitable carrier in licensed or unlicensed radio spectrum. The communication links 113 facilitate communication between one or more of the remote units 105 and/or one or more of the base units 111.

In one implementation, the SNPN 120 contains a 5G core (“5GC”) or a evolved packet core (“EPC”), which may be coupled to a data network (e.g., the data network 140, such as the Internet and private data networks, among other data networks). As depicted, the SNPN 120 includes several network functions (“NFs”). The SNPN 120 includes at least one user plane function (“UPF”) 121 that serves the access network 110. The SNPN 120 also includes multiple control plane functions including, but not limited to, an AMF 123, a Session Management Function (“SMF”) 125, a Policy Control Function (“PCF”) 126, an enhanced Authentication Server Function (“eAUSF”) 127, a Network Exposure Function 128, and a Unified Data Management/Unified Data Repository (“UDM/UDR”) 129. Please note that the UDM and UDR may be implemented in independent network functions with a standardized interface allowing signaling exchange between them, but for simplicity it is assumed herewith that they are co-located. In certain implementations, the mobile core network 130 may also include a Network Repository Function (“NRF”) (used by the various NFs to discover and communicate with each other over application programming interfaces (“APIs”)), or other NFs defined for the 5GC. Although specific numbers and types of network functions are depicted in FIG. 1, one of skill in the art will recognize that any number and type of network functions may be included in the SNPN 120.

In various implementations, the SNPN 120 has a service level agreement with the mobile core network. As such, the SNPN 120 may act as an authentication proxy for a remote unit 105 having a subscription with the mobile core network 130, as discussed in further detail with reference to FIGS. 2, 3A, 4A, and 5A. Additionally, the SNPN 120 may receive subscription data for the remote unit 105 (an external subscriber) from the mobile core network 130, as discussed in further detail with reference to FIGS. 2, 3B, 4B, and 5B.

In one implementation, the mobile core networks 130 is a 5G core (“5GC”) or a evolved packet core (“EPC”), which may be coupled to a data network (e.g., the data network 140, such as the Internet and private data networks, among other data networks). The present disclosure is not intended to be limited to the implementation of any particular wireless communication system architecture or protocol.

The mobile core network 130 includes several NFs. As depicted, the mobile core network 130 includes at least one UPF 131 that serves the access network 110. The mobile core network 130 also includes multiple control plane functions including, but not limited to, an AMF 133, a SMF 135, an Application Server/Application Function (“AS/AF”) 136, a PCF 137, an AAA server 138, and a UDM/UDR 139. In certain implementations, the mobile core network 130 may also include a Network Exposure Function (“NEF”), an AUSF, an NRF, or other NFs defined for the 5GC. Although specific numbers and types of network functions are depicted in FIG. 1, one of skill in the art will recognize that any number and type of network functions may be included in the mobile core network 130.

In various implementations, the SNPN 120 and/or mobile core network 130 support different types of mobile data connections and different types of network slices, wherein each mobile data connection utilizes a specific network slice. Here, a “network slice” refers to a portion of the mobile core network 140 optimized for a certain traffic type or communication service. A network slice instance may be identified by a single-network slice selection assistance information (“S-NSSAI”), while a set of network slices for which the remote unit 105 is authorized to use is identified by network slice selection assistance information (“NSSAI”).

Each network slice includes a set of control plane and user plane network functions, wherein each network slice is optimized for a specific type of service or traffic class. In certain implementations, the various network slices may include separate instances of network functions. In some implementations, the different network slices may share some common network functions. In one example, each network slice may include a dedicated SMF, PCF for SMF and a UPF, with the various network slices in the PLMN/SNPN sharing an AMF, PCF for AMF, and UDM. In another example, each network slice may include a dedicated AMF, PCF(s), SMF and UPF. The different network slices are not shown in FIG. 1 for ease of illustration, but their support is assumed.

FIG. 2 depicts a network deployment 200 comprising a UE 205 which connects to an access network 207 an attempts to register with a visited network, the 5G core network (“5GC”) 210, which is one implementation of the SNPN 120. Here, the UE 205 does not have a subscription (or other account) with the 5GC 210, but instead has a subscription (or other account) with the service provider (“SP”) 221, which is one implementation of the mobile core network 130. FIG. 2 represents a simplified deployment of the wireless communication system 100, where the UE 205 is one implementation of the remote unit 105.

According to one solution, the UE subscription data is stored (on-demand/temporary or pre-provisioned/long-term) in the SNPN's domain, e.g., in UDM/UDR 219 of the 5GC 210. Here, the UDM/UDR 219 is one implementation of the UDM/UDR 129. The UDM/UDR 219 can be a known UDM/UDR, but it can be a specific UDM/UDR providing additional functionality for serving external subscribers like disclosed in this document (e.g., providing mapping of external (service) subscription data to subscription data to be used in the SNPN; support handling of subscription retrieval parameter; support of signaling exchange with external AAA server, etc.). The benefit of such solution is that all NFs in the 5GC 210 (i.e., visited SNPN) can use the UE subscription as if the SNPN were the home SNPN. The paths 231 and 233 shows the signaling flow exchange for the UE subscription data provisioning in the SNPN's UDM/UDR 219. The signaling flow can be direct between UDM/UDR 219 and AAA server 225 (path 231) or traversing the NEF 218 (path 233). Alternatively, the signaling flow between UDM/UDR 219 and AAA server 225 may traverses the eAUSF 217. The benefit of the latter alternative is that the eAUSF 217 may already provide connectivity to the AAA server 225, e.g., for the UE primary authentication and authorization, so such connectivity can be re-used. The UPF 211 interacts with the AS/AF 223 in the SP 221.

The path 235 shows the signaling flow exchange for the primary network access authentication and authorization. The eAUSF 217 can be a known AUSF function, but can be also considered as enhanced AUSF implementing additional functionality (e.g., AAA proxy functionality), or it can be a stand-alone function implementing AAA message routing or providing transport layer security for the AAA messages between the SNPN (5GC 210) and the AAA server 225. The benefit of independent eAUSF function would be that the security signaling exchange for external subscribers (e.g., UE 105 or 205) is separated from the signaling for the SNPN own subscribers, which may use the known AUSF function. Note that the AAA messaging may conform with any Diameter, Radius, or other AAA protocol.

The SP 221 is a subscription owner (SO) of the UE 205. The SP 221 stores a service subscription information which may or may not be used as is in the visited network (e.g., SNPN/5GC 210) which deploys 5GS. Therefore, the 5GC 210 may use the service subscription information to generate subscription data for the UE 205. The mapping of service subscription information to subscription data can be performed by implementation means in the UDM/UDR 219, or the UDM may use support from a BSS (business support system) in the SNPN, or support from the OAM (operations, administration and management) system of the SNPN, or by other means. The mapping rules/guidelines of service subscription information to subscription data can be part of the service level agreement between the SNPN and the SO.

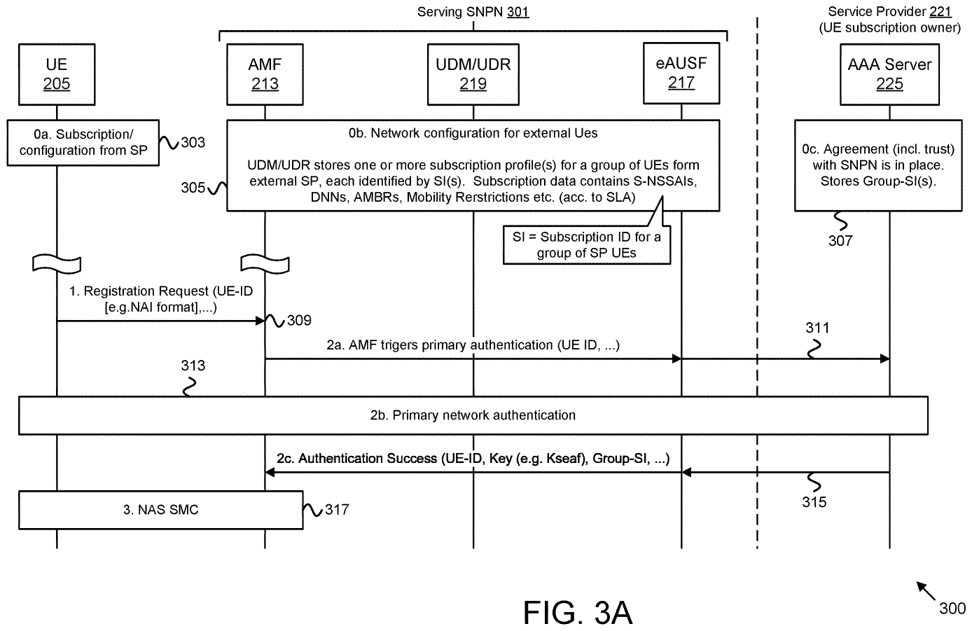

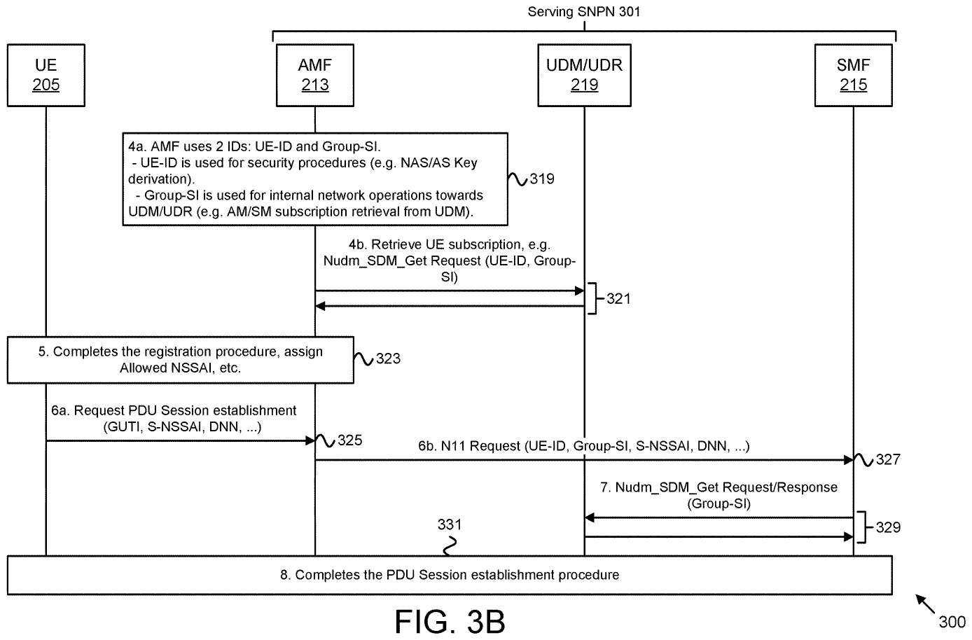

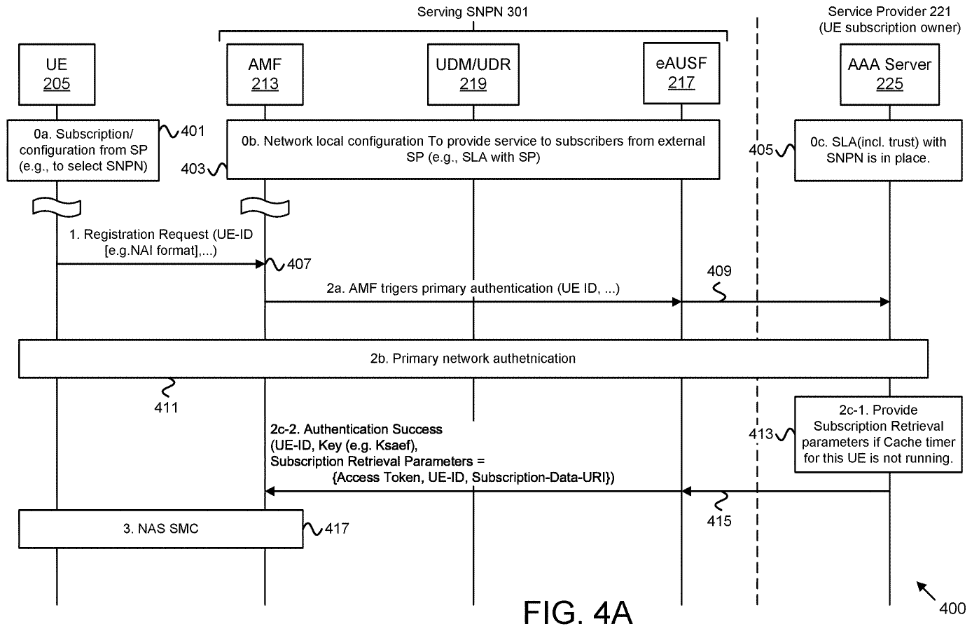

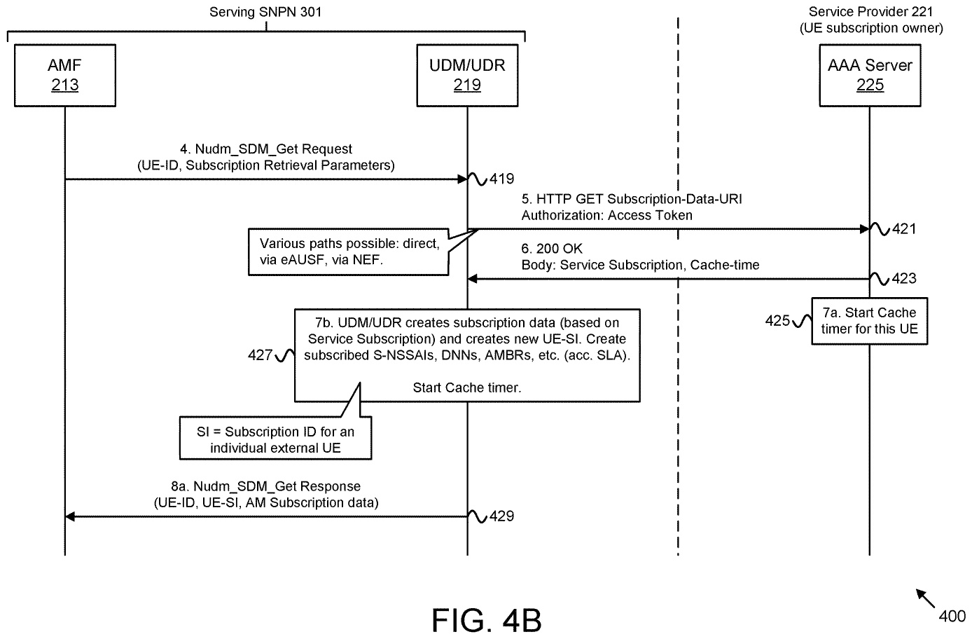

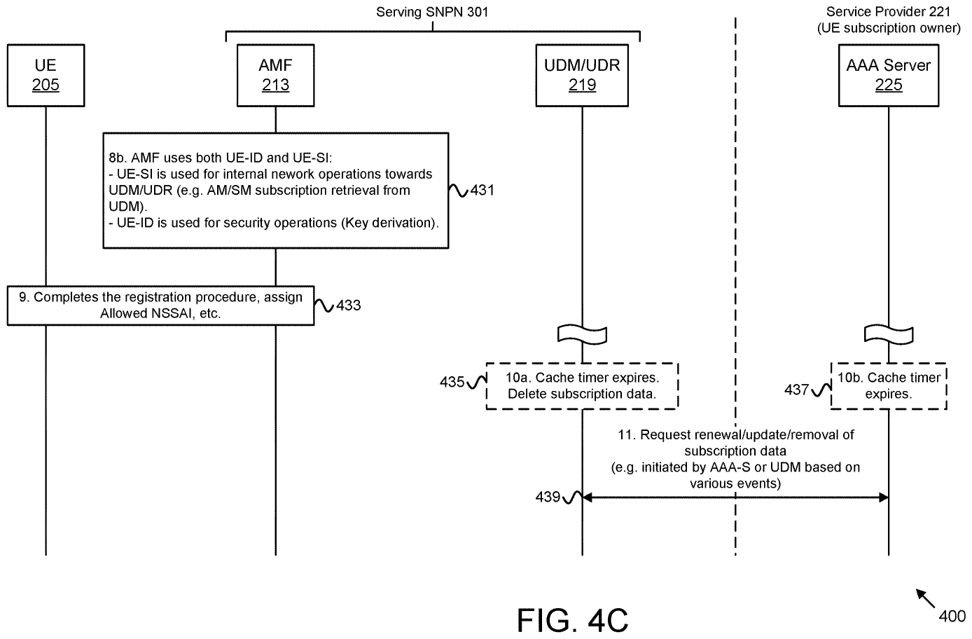

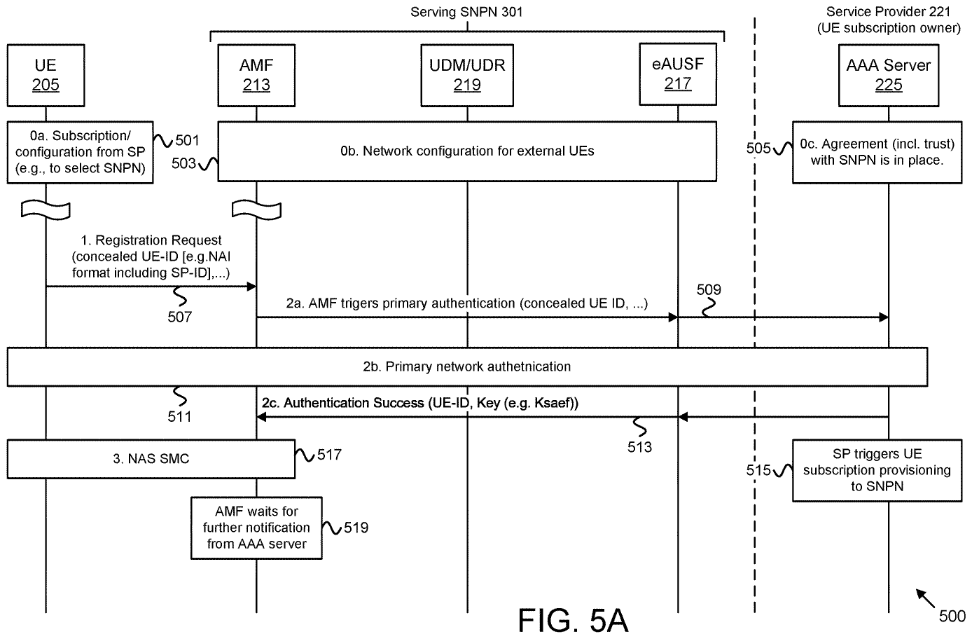

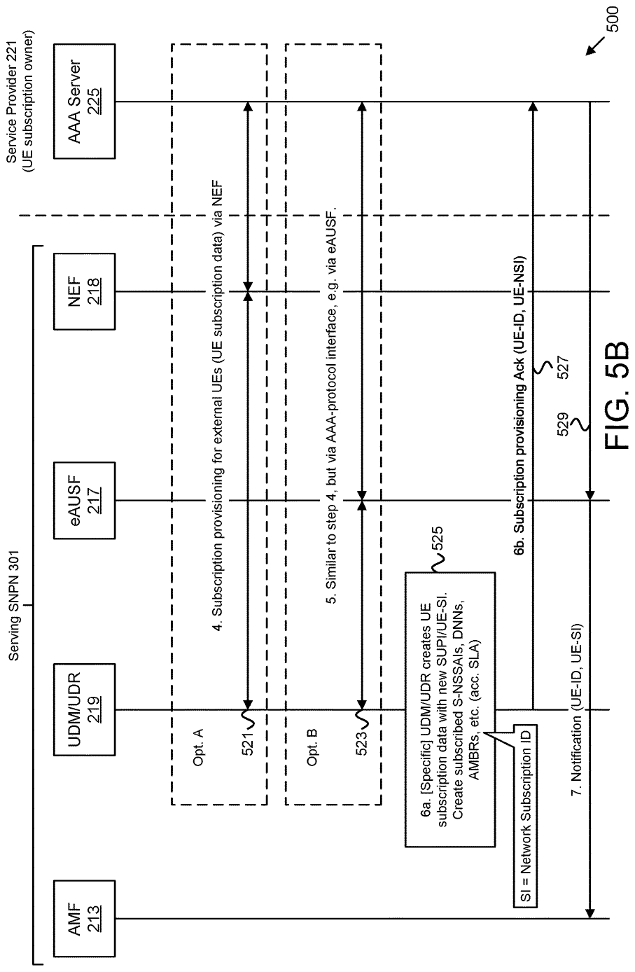

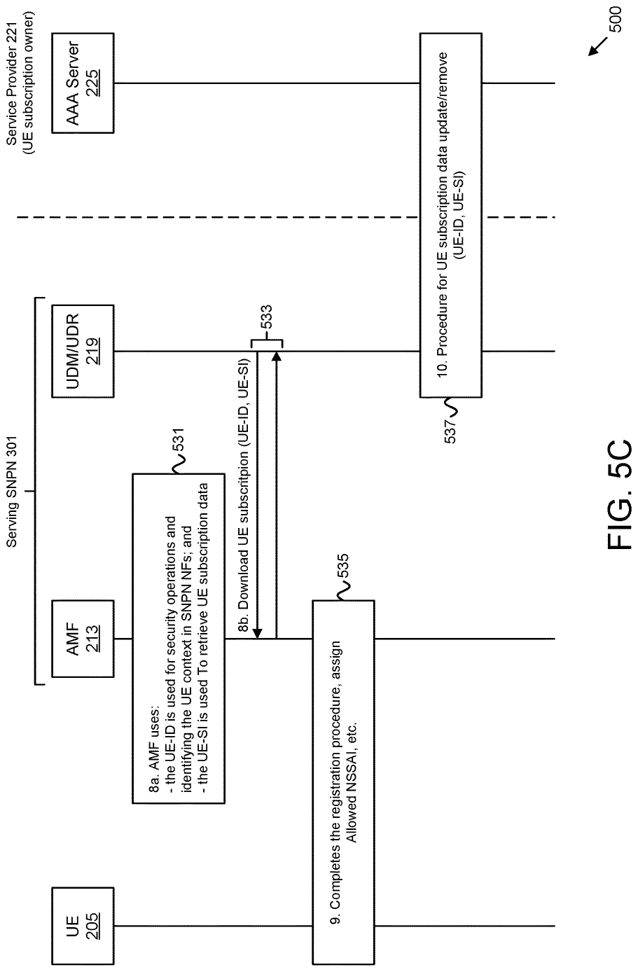

The subscription data for the UE 205 is either a) pre-provisioned in the SNPN/5GC 210, or b) provisioned on-demand to the SNPN/5GC 210. FIG. 3A-3B describe solutions where the subscription data is pre-provisioned in the SNPN. FIG. 4A-4C and 5A-5C describe solutions where the subscription data is provisioned on-demand to the SNPN. It can be noted that the UE subscription data stored in the SNPN (e.g., UDM/UDR 219) does not include the security-related data, e.g., UE Keys (symmetrical keys) which are stored in the SO domain (e.g., AAA server). The UE subscription data stored in the SNPN may be like the data structure as known from the specification 3GPP Technical Specification (“TS”) 23.502.

The UDM/UDR 219 generates a UE subscription identifier (SI) for the provisioned subscription data. This (generated) SI may be different than an (external) SI used by the SP 221. In various implementations, the generated SI is sent to the AMF 213 and used internally in the SNPN/5GC 210 while the UE 205 is served by the visited SNPN/5GC 210. Note that the SI is different than the UE-ID (i.e., Subscription Permanent Identifier (“SUPI”) and/or Subscription Permanent Identifier (“SUPI”) resulting from the Registration Request message) of the UE 205.

The AMF 213 uses both UE identities (i.e., the UE-ID and the SI) in the 5GC 210 as follows: The UE-ID is used for security procedures (e.g., key derivation in the AMF 213, signaling exchange with the eAUSF 217 or AAA server 225). The UE-SI is used for subscription data retrieval from the UDM/UDR 219. The AMF 213 receives the SI from either a) the AAA server during the authentication procedure, or b) from the UDM during the subscription retrieval procedure. The AMF 213 populates the SI to the other NFs (SMFs, PCF, etc.) during various procedures.

FIGS. 3A-3B depict a procedure 300 for registering a UE 205 with a visited SNPN, in accordance with aspects of the present disclosure. The procedure 300 involves the UE 205 (e.g., one implementation of the remote unit 105), a serving SNPN 301 comprising the AMF 213, the UDM/UDR 219, the eAUSF 217, and the AAA server 225 in the service provider network (i.e., the UE subscription owner). The procedure 300 represents a first solution for providing subscription data for an external subscriber and details signaling flow for how the UE 205 may register and establish a data connection (e.g., a PDU session, as depicted) with the SNPN 301 using the pre-provisioned subscription data.

The procedure 300 assumes that the Serving SNPN 301 and the SP 221 have setup an SLA. The Serving SNPN 301 may generate and store one or more subscription profiles for different groups of SP UEs (having same or similar service subscription parameters in the SP/SO). The SNPN 301 creates a subscription identifier (SI or Group SI) associated with the subscription data and sends the (generated) SI to the SP 221.

Upon registration procedure, the AMF 213 triggers the primary authentication for network access using the concealed UE-ID provided by the UE 205. After successful authentication, the SP's AAA server 225 provides the de-concealed UE-ID and the (Group) subscription ID (Group-SI) to the Serving SNPN 301 (e.g., to the AMF 213). The AMF 213 and other NFs uses the Group-SI as identifier to retrieve the subscription data from UDM/UDR 219. Note that the AMF 213 may send both the UE-ID and Group-SI to other NFs for establishing UE context.

Referring to FIG. 3A, the procedure 300 begins at step 0a where the UE 205 has a subscription with the SP 221 (see block 303). The subscription is identified by a UE-ID. The UE-ID may include the identity of the SP 221, as described in step 1.

At step 0b, the SNPN 301 stores one or more subscription data sets for different groups of UEs, which are SP subscribers (see block 305). The subscription data set is generated and stored based on the SLA with the SP 221 and may contain the typical subscription parameters like Mobility Restrictions, S-NSSAI(s), DNN(s), AMBR(s), etc. In one implementation, the subscription data set does not contain security parameters (e.g., Key material for the UE or group of UEs). Each subscription data/profile/set is associated with a unique subscription identifier (SI). The SI can be generated internally by the SNPN 301.

For example, the SP 221 may have several types of subscribers/UEs, which are allowed to use different SP services or allowed to have different types of network connectivity service. Some of the SP UEs may be allowed to use Ultra Reliable and Low Latency Communications (“URLLC”) services and others massive internet-of-things (“IoT”) services. In such case, the SP may request multiple service or connection types to the SNPN 301, which would result in the creation of multiple subscription data profiles/sets (e.g., subscription types) in the SNPN 301. The SNPN 301 would assign an SI (i.e., Group-SI) for each of the subscription data profiles/sets.

At step 0c, the SI is provided to the SP 221 (see block 307). The exchange with the SP 221 can happen either during the SLA negotiation or via other signaling means. The SP 221 is made aware about the subscription type in the SNPN 301 which is identified by the SI. The SP 221 may associate a specific UE (service) subscription with the SI received from the SNPN 301. The SP 221 may have contract with multiple SNPNs, and the SP 221 may maintain multiple SIs from different SNPNs for the same (service) subscription in the SP/SO. Further, the SI is also used as Group-SI, as the subscription data set in the UDM/UDR 219 can be applied to one or multiple UEs from the SP 221. Please note that the format of the SI may be the same for group SI and individual SI, i.e., the SI format itself does not reveal whether one or multiple subscriptions are identified by the SI. However, it is also possible that SI may have a different format for group SI and individual SI, e.g., there may be a special bit/flag in the SI string indicating whether the SI is for a group or individual subscriptions. In one example, the SI may have the format of SUPI or International Mobile Subscriber Identity (“IMSI”).

At step 1, the UE 205 selects the SNPN 301 as suitable serving network and sends Registration Request message (see messaging 309). The UE 205 includes its UE identifier (UE-ID). For example, the UE-ID can be in form of Network Access Identifier (“NAI”), where the “realm” part of the NAI identifies the UE's subscription owner (“SO”), i.e., the SP 221. As such, this UE-ID is a subscriber identity for the SP 221 (i.e., external subscriber identity), an external network from the perspective of the SNPN 301.

At step 2a, the AMF 213 triggers the primary network authentication procedure for network access (see messaging 311). The AMF 213 may select a specific AUSF (e.g., eAUSF 217) in the SNPN 301 based on the SO identifier (“SO-ID”) and/or SP identifier (“SP-ID”), which is derived from the UE-ID. For example, if the “realm” part of the UE-ID indicates a SO-ID which is not PLMN ID or SNPN ID, the AMF 213 is permitted to select the eAUSF 217 in its own network to send the authentication request. The AMF 213 may be pre-configured with the eAUSF identifier (“ID”) or the AMF 213 may discover the eAUSF ID via the NRF functionality. The AMF 213 may use the service based interface (“SBI”) request/response exchange with the eAUSF 217. The eAUSF 217 may generate AAA message towards the AAA server 225. The AAA message sent in this step has the target of the AAA server 225 derived from the SO-ID. The eAUSF 217 may have transport layer security setup in order to securely exchange AAA message signaling with the AAA server 225. The eAUSF 217 may map the AAA server ID in form of SO-ID into an internet protocol (“IP”) address of the AAA server 225. The eAUSF 217 may be pre-configured with the AAA server 225 address or the eAUSF 217 may discover the AAA server IP address using the SO-ID and constructing a Fully Qualified Domain Name (“FQDN”).

At step 2b, the UE 205 is authenticated by the AAA server 225 (see block 313). Any Extensible Authentication Protocol (“EAP”) authentication method may be used. At step 2c, after the EAP authentication is completed, the AAA server 225 sends the authentication result (Success or Failure) to the eAUSF 217 and AMF 213 (see messaging 315). In case of Authentication result is successful, the message may also contain at least one of the following parameters: UE-ID (identifying the UE at the SO/SP), Key material (e.g., Kseaf for deriving further keys for Non-Access Stratum (“NAS”) layer or Access Stratum (“AS”) layer), a Group-SI (used to identify the UE subscription data in the serving SNPN 301).

The Group-SI may be formatted in a way to indicate that this is a group ID, so that the AMF 213 knows to include an additional individual (unique) UE identifier in the interaction with the NFs in the SNPN 301. The additional unique UE identifier would be used as an identifier for the UE context in the different NFs, whereas the Group-SI is used as subscription identifier mainly towards the UDM/UDR 219. Please note that in another implementation the Group SI may not be used and instead an indication is sent to the AMF 213 to indicate that the (external) UE-ID can be used also for identification of the UE subscription data in the SNPN 301 (e.g., UDM/UDR 219, SMF 215). In such cases the AMF 213 uses the UE-ID (although based on external subscription identity in SO/SP) in the signaling towards UDM/UDR 219 and other NFs within the SNPN 301. The signaling messages within SNPN 301 may include an additional flag/parameter indicating that the signaling messages containing the (external) UE-ID should be routed internally in the SNPN 301. The signaling routing infrastructure in the SNPN 301 is correspondingly configured to correctly route the signaling message and discover the correct UE subscription data.

In case of authentication failure indicated from the AAA server 225, the AMF 213 would complete the registration procedure by sending Registration Reject message to the UE 205 with an appropriate reject cause. The AAA server 225 may not send the Group-SI to the AMF 213, as it is not needed in the AMF 213 in failure case.

At step 3, the AMF 213 performs NAS security mode command (“SMC”) with the UE 205 to setup the NAS security with the UE 205 (see block 317). The AMF 213 uses the Key material received in step 2c to derive the further security keys, e.g., NAS key and AS/gNB keys.

Continuing on FIG. 3B, at step 4a, the AMF 213 uses two identifiers for the UE 205: the UE-ID and the Group-SI (see block 319). The identifiers are used for different purposes. The Group-SI is used for internal network operations to retrieve subscription data from UDM/UDR 219 (e.g., AM/SM subscription retrieval from UDM/UDR 219). Any NF which needs to contact the UDM/UDR 219 for subscription data download has to use the Group-SI.

The UE-ID is used for security procedures, e.g., deriving of (NAS or AS) security keys for the UE 205, communication towards the eAUSF 217 during (re-)authentication/authorization procedure. Further, the UE-ID is used to uniquely to identify UE context in the SNPN 301's NFs (e.g., AMF 213, SMF 215, UDM/UDR 219, PCF 216, etc.).

Even though the UE-ID is from an external SP/SO domain, the AMF 213 determines to select and contact a UDM/UDR 219 in its own network (SNPN 301). This is a new feature of the AMF 213 to perform a selection of UDM/UDR 219 in the SNPN 301 despite the network identifier (e.g., “realm” part of the UE-ID, in NAI format) targeting to an external network. In one implementation, the UDM/UDR 219 is a specific UDM instance deployed for UEs from external SPs. For the purpose of UDM selection in the AMF 213, one of the following may be used: 1) the AMF 213 may be pre-configured with the UDM ID supporting maintenance of subscription data for external subscribers, or 2) the AMF 213 requests the NRF to resolve the UDM ID by using a new parameter, e.g., the “realm” part of the UE-ID.

At step 4b, the AMF 213 selects a UDM/UDR 219 as per step 4a. The AMF 213 may register with the UDM/UDR 219 using Nudm_UECM_Registration for the access to be registered (and subscribes to be notified when the UDM/UDR 219 deregisters this AMF 213) using the UE-ID. The AMF 213 retrieves the subscription data of the UE 205 from the UDM/UDR 219, e.g., access and mobility (AM) subscription data, SMF Selection Subscription data, UE context in SMF data and Location Services (“LCS”) mobile origination subscription (see messaging 321). The AMF 213 uses the Group-SI as a subscription identifier for this UE 205 towards the UDM/UDR 219, whereas the UE-ID used to identify the UE 205 in the UDM/UDR 219 for the UE-context (not to identify the UE subscription data).

For example, the AMF 213 can use Nudm_SDM_Get Request with parameters [UE-ID, Group-SI, <other parameters>] to retrieve the UE subscription data. The UE-ID is used to uniquely identify the UE context created in the UDM/UDR 219, e.g., the UDM/UDR 219 needs to store serving AMF ID and other information for this UE 205.

Please note that according to the implementation described in step 2c where the Group SI is not used but instead the indication that the (external) UE-ID can be used also for identification of the UE subscription data in the SNPN 301, the AMF 213 uses in the step 4b this indication together with the (external) UE-ID in the signaling towards UDM/UDR 219.

At step 5, the AMF 213 completes the registration procedure, e.g., as per 3GPP specification TS 23.502 (see block 323). For this purpose, the AMF 213 derives the parameters to be included in the Registration Accept message, e.g., Allowed NSSAI, Mobility Restrictions, etc.

At step 6a, the UE 205 may request PDU Session establishment for a particular S-NSSAI (see messaging 325). At step 6b, the AMF 213 selects an appropriate SMF 215 based on the stored UE context and the S-NSSAI or DNN (if any) requested by the UE 205 in step 6a. In the N11 message to the SMF 215, the AMF 213 includes an additional information of the Group-SI (see messaging 327).

For example, the AMF 213 may use the service operation Nsmf_PDUSession_CreateSMContext Request with parameters: [SUPI, Group-SI, selected DNN, UE-requested DNN, S-NSSAI(s), PDU Session ID, <other parameters>]. Alternatively, the AMF 213 may use the service operation Nsmf_PDUSession_UpdateSMContext Request with parameters: [SUPI, DNN, S-NSSAI(s), SM Context ID, <other parameter>]. The SUPI would be the UE-ID, discussed above, and the Group-SI would be the new parameter to be used in the SMF 215 to request the UE subscription data (e.g., from UDM/UDR 219). The SMF 215 needs to uniquely identify the UE context, as the SMF 215 subscribes for notifications from AMF 213.

At step 7, the SMF 215 uses the Group-SI to retrieve the UE's Session Management (SM) subscription data from the UDM/UDR 219 (see messaging 329). The UE-ID is used in the SMF 215 to uniquely identify the UE context. Please note that according to the implementation described in step 2c where the Group SI is not used but instead the indication that the (external) UE-ID can be used also for identification of the UE subscription data in the SNPN 301, the SMF 215 uses in the step 7 this indication together with the (external) UE-ID in the signaling towards UDM/UDR 219.

For example, the SMF 215 may use the service operation Nudm_SDM_Get with parameters: [SUPI, Group-ID, Session Management Subscription data, <other parameters>]. The SUPI would be the UE-ID, discussed above, and the Group-SI would be the new parameter to be used by the SMF 215 to request the UE subscription data (e.g., from UDM/UDR 219). If the SMF 215 needs to request SM policy from PCF, then the SMF 215 includes an additional information of the Group-SI to the PCF. The PCF would use the Group-SI to request UE's subscription data from the UDM/UDR 219.

At step 8, the SMF 215 completes the PDU Session establishment procedure with the UE 205 (see block 331). If the UE 205 is assigned to use more than one network slice in the SNPN 301, i.e., the Allowed NSSAI in the Registration Accept message contains 2 or more S-NSSAIs, then it is recommended that the SNPN generates and sends UE Route Selection Policy (“URSP”) rules (meant as Network Slice Selection Policy (“NSSP”) rules) to the UE. This can be performed by the PCF for AM policies selected by the AMF. The PCF uses the subscription data received from the UDR to create the URSP rules.

The benefit of this first solution is that the UE-specific signaling exchange between the SNPN 301 and the SP 221 is reduced to the UE (primary) authentication and authorization procedure. Once the primary authentication is successfully completed, the SNPN 301 can serve the UE 205 without further interaction with the SP 221. However, in the first solution the UE subscription data cannot be changed dynamically if the service subscription in the SP 221 changes. If the service subscription changes, the SP/SO 221 needs to re-negotiate or update SLA with the SNPN 301. FIGS. 4A-4C and 5A-5C describe solutions allowing dynamic change of subscription data in the SNPN 301.

FIGS. 4A-4C depict a procedure 400 for registering a UE 205 with a visited SNPN, in accordance with aspects of the present disclosure. The procedure 400 involves the UE 205 (e.g., one implementation of the remote unit 105), a serving SNPN 301 comprising the AMF 213, the UDM/UDR 219, the eAUSF 217, and the AAA server 225 in the service provider network (i.e., the UE subscription owner). The procedure 400 represents a second solution for providing subscription data for an external subscriber and details signaling flow for how the UE 205 may register and establish a data connection (e.g., a PDU session, as depicted) with on-demand provisioning (pull method) of external subscription to the Serving SNPN 301.

The procedure 400 assumes that the Serving SNPN 301 and the SP 221 have setup an SLA. The AAA server 225 sends to the AMF 213 one or more subscription retrieval parameters: e.g., 1) credentials for UE subscription data retrieval (e.g., an Access Token); and 2) the subscription data destination address (e.g., the Uniform Resource Identifier (“URI”)). The AMF 213 uses the subscription retrieval parameters to download the UE subscription data from the UDM/UDR 219.

The UDM/UDR 219 retrieves the UE service subscription from the AAA server 225 using the subscription retrieval parameters. The UDM/UDR 219 creates a temporary UE subscription data (based on the UE service subscription) and generates a UE subscription identifier (UE-SI) to be used in the SNPN 301 for subscription data retrieval from all NFs.

At FIG. 4A, the procedure 400 begins at step 0a where the UE 205 has a subscription with the SP 221 (see block 401). The subscription is identified by a UE-ID. The UE-ID also includes the identity of the SP 221. At step 0b, the SNPN 301 may store network local configuration to provide network service to subscribers from external SO/SP 221 (see block 403). For example, based on SLA with a particular SO/SP 221, the SNPN 301 can internally configure certain NFs (e.g., AMF 213, UDM/UDR 219, eAUSF 217) to allow network access for SO subscribers. Based on the SLA, the UDM/UDR 219 can be able to perform mapping of UE service subscription data from SO/SP to UE subscription data in the SNPN.

At step 0c, the SP 221 stores the agreement with the particular SNPN 301 (see block 405). This agreement may include a trust relationship and services and services parameters to be offered from the SNPN 301 to the SP subscribers. There may be a trust connection set up between SP 221 and SNPN 301 (e.g., eAUSF or AAA proxy). At step 1, the UE 205 selects the SNPN 301 as suitable serving network and sends Registration Request message (see messaging 407). This step is as described above with reference to step 1 of FIG. 3A.

At step 2a, the AMF 213 triggers the primary network authentication procedure for network access (see messaging 409). This step is as described above with reference to step 2a of FIG. 3A. At step 2b, the UE 205 is authenticated by the AAA server 225 (see block 411). Any EAP authentication method may be used.

At step 2c-1, after successful authentication, the AAA server 225 may determine whether the (external) service subscription for this UE 205 has been already provided to this SNPN 301 and whether the service subscription has expired (see block 413). At step 2c-2, the AAA server 225 sends the authentication result (e.g., Success) to the AMF 213 (see messaging 415). The authentication result message may also contain at least one of the following parameters: UE-ID (identifying the UE at the SO/SP), Key material (e.g., Kseaf for deriving further keys for NAS layer or AS layer). In the case that the AAA server determines that the (external) service subscription is to be provided to the SNPN, the AAA server 225 sends the Subscription Retrieval Parameters to the SNPN 301 (i.e., to the AMF 213). The AAA server 225 can use either the same AAA message carrying the Authentication Result or a separate AAA message.

The Subscription Retrieval Parameters can include at least one of: UE-ID, Access Token (e.g., unique token to be used to retrieve the particular UE service subscription from the AAA server), Subscription-Data-URI (e.g., target address of subscription data, e.g., URI). The Subscription-Data-URI can contain a UE-ID, or AAA server ID (FQDN or IP address) and other information needed to uniquely identify the UE's service subscription in the SO domain and in the AAA server 225. Another implementation can be applicable here as well similar to the implementation described in step 2c in FIG. 3A where the Access Token and Subscription-Data-URI are not sent to the AMF 213 and instead an indication is sent to indicate that the (external) UE-ID can be used also for identification of the UE subscription data in the SNPN 301. In such case, the Subscription Retrieval Parameters contain 1) an (external) subscription identifier, e.g., (external) UE-ID, assuming that the UE-ID comprises the UE identity in the SO domain and the address (URI, or domain name) of the target SO server/domain where UE's service subscription data is stored and 2) an indication to use the (external) UE-ID for identification of the UE subscription data in the SNPN 301. The AMF 213 uses both the UE-ID and the indication to use the (external) UE-ID as subscription identifier in the SNPN 301 when retrieving UE subscription data from UDM/UDR 219 and also signals both parameters to the other NFs in the SNPN 301 which need UE subscription data.

One reason for the AAA server 225 to send additional Access Token in the Subscription Retrieval Parameters to the SNPN (e.g., AMF) is that the AAA server 225 may want to protect the UE Service Subscription data to be retrieved from such an entity (e.g., AMF213 or UDM/UDR 219 in SNPN 301), which is authorized from the AAA server 225. The Access Token or Subscription-Data-URI are meant to authorize the UDM in the AAA server 225. Upon reception of the AAA message, the AMF 213 stores the UE-ID and the associated Subscription Retrieval Parameters to be used for UE subscription retrieval.

At step 3, the AMF 213 performs NAS security mode command (SMC) with the UE 205 to setup the NAS security with the UE 205 (see block 417). The AMF 213 uses the Key material received in step 2c-2 to derive the further security keys.

Continuing on FIG. 4B, at step 4 the AMF 213 initiates UE subscription data retrieval with the UDM/UDR 219 (see messaging 419). Based on the received external Subscription Retrieval Parameters, the AMF 213 determines to select a UDM in the SNPN domain, but such UDM which is capable of handling external Subscription Retrieval Parameters. The AMF 213 sends Nudm_SDM_Get Request which may contain one of: UE-ID, Subscription Retrieval Parameters, etc. The selection of UDM/UDR 219 is as described above with reference to step 4a of FIG. 3A.

At step 5, the UDM/UDR 219 initiates a procedure to retrieve the UE service subscription data with the AAA server 225 (see messaging 421). For example, the UDM/UDR 219 may use the following Hypertext Transfer Protocol (“HTTP”) GET Subscription-Data-URI Authorization: Access Token.

One of the following methods to exchange signaling (i.e., signaling path) with AAA server can be considered: 1) The UDM/UDR 219 may directly send AAA messages (or HTTP protocol messages) to the AAA server 225, e.g., HTTP GET message including Subscription-Data-URI and Access Token for Authorization; 2) The UDM/UDR 219 may exchange signaling with a AAA proxy or eAUSF 217 in the SNPN domain (for example, there may be a common eAUSF or AAA proxy for exchanging the signaling for the primary authentication (step 2a, 2b, 2c-2) and for the subscription provisioning); 3) The UDM/UDR 219 may use the services from NEF and North Bound Interfaces to contact the AAA server 225. In third case, it is required that the NEF functionality be enhanced/modified to be used to exchange AAA-relevant information between UDM/UDR 219 and AAA server 225.

At step 6, the AAA server 225 replies to the request in step 5 (see messaging 423). For example, the AAA server 225 may send “200 OK” message including at least one of the parameters: Service Subscription, Cache-time, and other parameters.

The Service Subscription contains information about the services which the UE is subscribed/allowed to use according to the subscription owner. For example, the Service Subscription may contain one of: 1) type of the allowed connections (e.g., audio/video streaming, audio/video interactive application, or low latency Augmented Reality and/or Virtual Reality (“AR/VR”) application, Multimedia Broadcast/Multicast Service (“MBMS”) server, etc.); 2) the allowed max bit rate per connection; 3) the target data network per connection (e.g., Internet, SP provider domain, etc.); and/or 4) restriction of the access type for the UE 205 (e.g., use of New Radio (“NR”) access only, or Long-Term Evolution (“LTE”) and NR access).

At step 7a, the AAA server 225 keeps track that the UE service subscription data has been sent to the SNPN 301 (see block 425). The AAA server 225 starts a timer having a value of ‘Cache time’ for this UE 205. This timer is used as validity time for which the SNPN 301 is allowed to store and use the UE Service Subscription data.

At step 7b, the UDM/UDR 219 creates subscription data based on received Service Subscription for the UE 205 (see block 427). The UDM/UDR 219 generates a new subscription identifier (SI) for the created subscription data, i.e., the UE-SI. Note that here the Subscription ID is for an individual external UE. The UDM/UDR 219 may take into account the Service Level Agreement with the SP/SO when creating the UE subscription data.

The subscription data contains all data needed for the normal network connectivity for the UE 205, i.e., AM subscription data (including subscribed S-NSSAIs, DNNs, mobility restrictions (preferred RAT type, Service Area Restriction), Subscribed-UE-AMBR, etc.), Slice Selection Subscription data, SMF Selection Subscription data, Session Management Subscription data (including default DNN, default PDU Session Type, Subscribed-Session-AMBR, 5GS Subscribed QoS profile, etc.) and others.

The UDM/UDR 219 may insert the second subscription data (e.g., the UE subscription data) to the UDR, which is in this document is assumed to be co-located with the UDM/UDR 219. The at least one PCF 216 may request the UDR to retrieve the UE subscription data. The UDM/UDR 219 may start a timer with a value ‘Cache time’ as received from the AAA server in step 6.

At step 8a, the UDM/UDR 219 responds to step 4 by sending the UE subscription data to the AMF 213 (see messaging 429). The UDM/UDR 219 may send a new subscription identifier for the subscription data. For example, the UDM/UDR 219 may use the service operation Nudm_SDM_Get Response (UE-ID, UE-SI, AM Subscription data, etc.).

Continuing on FIG. 4C, at step 8b the AMF 213 stores the received UE subscription data (see block 431). The AMF 213 uses both UE identifiers, i.e., UE-ID and UE-SI, as described in step 4a of FIG. 3B.

At step 9, the AMF 213 completes the registration procedure, e.g., as per 3GPP specification TS 23.502 (see block 433). For this purpose, the AMF 213 derives the parameters to be included in the Registration Accept message, e.g., Allowed NSSAI, Mobility Restrictions, etc.

At step 10a, the UDM/UDR 219 runs the validity timer with the ‘Cache value,’ as per step 7 (see block 435). Upon expiration of the validity timer, the UDM/UDR 219 may (optionally) delete the UE subscription data. Alternatively, the UDM/UDR 219 may request the AAA server 225 to refresh the UE subscription data, as shown in step 11.

At step 10b, the AAA server 225 also runs the validity timer with the ‘Cache value’ (see block 437). Upon expiration of the validity timer in the AAA server 225, the AAA server 225 may (optionally) request the SNPN 301 to delete or to refresh the UE subscription data.

At step 11, the UDM/UDR 219 and AAA server 225 can perform one of the following procedures: renewal, update, or removal of the UE subscription data (see messaging 439). The operations of renewal, update or removal of the UE subscription data can be triggered either in the UDM/UDR 219 towards the AAA server 225, or in the AAA server 225 towards the UDM/UDR 219. The signaling path between the UDM/UDR 219 and the AAA server 225 can be the same as described in step 5.

These procedures can be triggered upon one of the following triggers: expiration of the validity timer in step 10a or 10b; or change of the Service Subscription data in the AAA server; or upon registration of the UE 205 with a new network, where the AAA server 225 can determine to remove the UE subscription data in the current SNPN 301. Note that the AAA messaging may conform with any Diameter, Radius, or other AAA protocol.

Please note that in another implementation of FIGS. 4A-4C, the UE-SI may not be used and instead an indication is sent to the AMF 213 to indicate that the (external) UE-ID can be used also for identification of the UE subscription data in the SNPN 301 (e.g., UDM/UDR 219, SMF 215, PCF, etc.).

The benefit of this second solution is that the UE Service Subscription data may be updated dynamically in the SP/SO 221 and, correspondingly, the UE subscription data may be updated in the serving SNPN 301.

Note that the use of the procedure 300 or the procedure 400 may be negotiated between the SNPN 301 and the SP/SO 221 during step 0. For example, the SP/SO 221 may use the procedure 300 (pre-provisioned subscriber data) for some SNPNs and the procedure 400 (dynamic provisioning of subscriber data) for other SNPNs.

FIGS. 5A-5C depict a procedure 500 for registering a UE 205 with a visited SNPN, in accordance with aspects of the present disclosure. The procedure 500 involves the UE 205 (e.g., one implementation of the remote unit 105), a serving SNPN 301 comprising the AMF 213, the UDM/UDR 219, the eAUSF 217, and the AAA server 225 in the service provider network (i.e., the UE subscription owner). The procedure 300 represents a third solution for providing subscription data for an external subscriber and details signaling flow for how the UE 205 may register and establish a data connection (e.g., a PDU session, as depicted) with dynamic provisioning (push method) of the external UE Service Subscription to the Serving SNPN 301 initiated by the AAA server 225. The third solution is based on the AAA server 225 triggering a push of the UE subscription data to the UDM/UDR 219 after successful primary authentication and authorization.

The procedure 500 assumes that the Serving SNPN 301 and the SP 221 have setup an SLA. The AAA server 225 sends to the AMF 213 one or more subscription retrieval parameters: e.g., 1) credentials for UE subscription data retrieval (e.g., an Access Token); and 2) the subscription data destination address (e.g., URI). The AMF 213 uses the subscription retrieval parameters to download the UE subscription data from the UDM/UDR 219.

The UDM/UDR 219 retrieves the UE service subscription from AAA server 225 using the subscription retrieval parameters. The UDM/UDR 219 creates a temporary UE subscription data (based on the UE service subscription) and generates a UE subscription identifier (UE-SI) to be used in the SNPN 301 for subscription data retrieval from all NFs.

At FIG. 5A, the procedure 500 begins at step 0a where the UE 205 has a subscription with the SP 221 (see block 501). At step 0b, the SNPN 301 may store one or more subscription data sets for different groups of UEs, which are SP subscribers (see block 503). At step 0c, the SI is provided to the SP 221 (see block 505). The steps 0a-0c are as described above with reference to steps 0a-0c of FIG. 4A.

At step 1, the UE 205 selects the SNPN 301 as suitable serving network and sends Registration Request message (see messaging 507). This step is also as described above with reference to step 1 of FIG. 4A.

At step 2a, the AMF 213 triggers the primary network authentication procedure for network access (see messaging 509). At step 2b, the UE 205 is authenticated by the AAA server 225 (see block 511). The steps 2a-2b are as described above with reference to steps 2a-2b of FIG. 3A.

At step 2c, after the EAP authentication is completed, the AAA server 225 sends the authentication result (Success or Failure) to the AMF 213 (see messaging 513). In case of Authentication result is successful, the message may also contain at least one of the following parameters: UE-ID (identifying the UE at the SO/SP), Key material (e.g., Kseaf for deriving further keys for NAS layer or AS layer), an Group-SI (used to identify the UE subscription data in the serving SNPN 301). Note that in the procedure 500, the AAA server 225 does not send subscription retrieval parameters to the SNPN 301 (i.e., to the AMF 213). Note that successful EAP authentication also causes the SP 221 to trigger UE subscription provisioning to the SNPN 301 (see block 515).

At step 3, the AMF 213 performs NAS security mode command (SMC) with the UE 205 to setup the NAS security with the UE 205 (see block 517). The AMF 213 uses the Key material received in step 2c to derive the further security keys. Afterwards, the AMF 213 waits for further notification from the AAA server 225 about the UE subscription (see block 519). Alternatively, the AMF 213 may request the AAA server 225 for UE subscription.

Continuing on FIG. 5B, the AAA server initiates dynamic provisioning of the serving SNPN 301 (i.e., UDM/UDR 219) using either the NEF 218 as intermediary (labelled ‘Option A’ in FIG. 5B) or using the eAUSF 217 as intermediary (labelled ‘Option B’ in FIG. 5B).

At step 4, after the successful authentication of the UE 205, the AAA server 225 triggers UE subscription provisioning procedure towards the SNPN 301 (Option A, see messaging 521). If the AAA server 225 is configured to use the North Bound Interface (NBI) towards the NEF 218 (e.g., during step 0), then the AAA server 225 may invoke NBI operation to provision the UE service subscription data to the UDM/UDR 219 via NEF 218. The NEF 218 is enhanced (or appropriately configured) to discover a UDM instance in the SNPN 301 which is capable to create UE subscription data for external subscribers.

At step 5 (an alternative to step 4), the AAA server 225 may send the UE Service Subscription data to the UDM/UDR 219 via the eAUSF function 217 (Option B, messaging 523). The benefit of Option B is that the AAA server 225 already has an association with the eAUSF 217 and can re-use this association for the signaling exchange with the UDM/UDR 219. Here, the eAUSF 217 is enhanced (or appropriately configured) to discover a UDM instance in the SNPN 301 which is capable to create UE subscription data for external subscribers. Note that the use of Option A or Option B may be configured during the SLA negotiation in step 0.

At step 6a, the UDM/UDR 219 creates subscription data based on received Service Subscription for the UE 205 (see block 525). The UDM/UDR 219 generates a new subscription identifier (SI) for the created subscription data, i.e., the UE-SI. Note that here the Subscription ID is a Network subscription ID. The UDM/UDR 219 may take into account the Service Level Agreement with the SP/SO when creating the UE subscription data.

The subscription data contains all data needed for the normal network connectivity for the UE 205, i.e., AM subscription data (including subscribed S-NSSAIs, DNNs, mobility restrictions (preferred RAT type, Service Area Restriction), Subscribed-UE-AMBR, etc.), Slice Selection Subscription data, SMF Selection Subscription data, Session Management Subscription data (including default DNN, default PDU Session Type, Subscribed-Session-AMBR, 5GS Subscribed QoS profile, etc.) and others. The UDM/UDR 219 may insert the second subscription data to UDR, as the PCF 216 may request the UDR to retrieve the UE subscription data.

At step 6b, the UDM/UDR 219 acknowledges the successful provisioning of the UE subscription data in the SNPN 301. The UDM/UDR 219 includes the subscription identifier (SI) assigned in step 6a. (see messaging 527)

At step 7, the AAA server 225 sends a Notification message to the AMF 213 including the subscription identifier (SI) received from the UDM/UDR 219 for the created UE subscription data in the SNPN 301 (see messaging 529).

Continuing on FIG. 5C, at step 8a the AMF 213 stores the received UE subscription data (see block 531). The AMF 213 uses both UE identifiers, i.e., UE-ID and UE-SI, as described in step 5a of FIG. 3B. At step 8b, AMF 213 retrieves the subscription data of the UE 205 from the UDM/UDR 219, e.g., access and mobility (AM) subscription data, SMF Selection Subscription data, UE context in SMF data and LCS mobile origination subscription (see messaging 533).

At step 9, the AMF 213 completes the registration procedure, e.g., as per 3GPP specification TS 23.502 (see block 535). For this purpose, the AMF 213 derives the parameters to be included in the Registration Accept message, e.g., Allowed NSSAI, Mobility Restrictions, etc.

At step 10, the UDM/UDR 219 and AAA server perform a procedure to maintain the UE subscription data in the SNPN, i.e., UE subscription data renewal, update, or removal (see block 537). The maintenance procedure can be triggered upon one of the following triggers: expiration of a validity timer; or change of the Service Subscription data in the AAA server; or upon registration of the UE 205 with a new network, where the AAA server 225 can determine to remove the UE subscription data in the current SNPN 301. The maintenance procedure may be as described above with reference to steps 10a, 10b, and 11 of FIG. 4C.

The benefit of this third solution is that the UE Service Subscription data may be updated dynamically in the SP/SO 221 and, correspondingly, the UE subscription data may be updated in the serving SNPN 301.

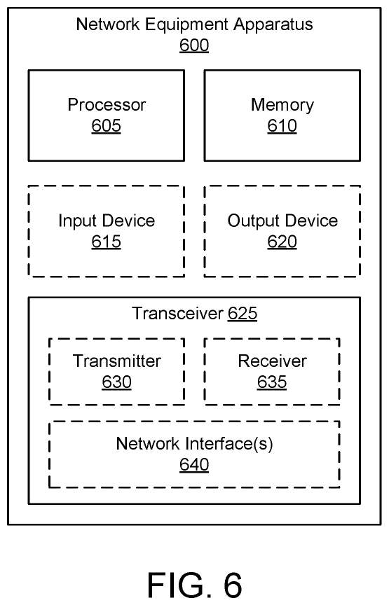

FIG. 6 depicts one implementation of a NE 600 that may be used for registering with a mobile network through another mobile network, in accordance with aspects of the present disclosure. In some implementations, the NE 600 may be one implementation of a 5G Residential Gateway (“5G-RG”). Furthermore, NE 600 may include a processor 605, a memory 610, an input device 615, an output device 620, a transceiver 625. In some implementations, the input device 615 and the output device 620 are combined into a single device, such as a touch screen. In certain implementations, the NE 600 does not include any input device 615 and/or output device 620.

As depicted, the transceiver 625 includes at least one transmitter 630 and at least one receiver 635. Here, the transceiver 625 communicates with one or more remote units 105. Additionally, the transceiver 625 may support at least one network interface 640, such as the N1 interface depicted in FIGS. 4A-4C. In some implementations, the transceiver 625 supports a first interface for communicating with a RAN node, a second interface for communicating with one or more network functions in a mobile core network (e.g., a 5GC) and a third interface for communicating with a remote unit (e.g., UE).

The processor 605, in one implementation, may include any known controller capable of executing computer-readable instructions and/or capable of performing logical operations. For example, the processor 605 may be a microcontroller, a microprocessor, a central processing unit (“CPU”), a graphics processing unit (“GPU”), an auxiliary processing unit, a field programmable gate array (“FPGA”), or similar programmable controller. In some implementations, the processor 605 executes instructions stored in the memory 610 to perform the methods and routines described herein. The processor 605 is communicatively coupled to the memory 610, the input device 615, the output device 620, and the first transceiver 625.

In various implementations, the processor 605 controls the NE 600 to implement the above described UDM/UDR behaviors. In some implementations, the processor receives, from a network function in the mobile communication network (e.g., from an AMF) and via a network interface 640, a request to provide a subscription data for a UE of an external subscriber. Here, the request contains at least one subscription retrieval parameter (e.g., Access Token, Subscription Retrieval URI) which indicates that the subscription data is stored in a subscription owner outside the mobile communication network.

In some implementations, the at least one subscription retrieval parameter comprises a credential (e.g., Access Token) to be used to retrieve the first subscription data, wherein the credential is provided to the network function by the subscription owner (e.g., AAA server). In some implementations, the at least one subscription retrieval parameter comprises a target address (e.g., Subscription Retrieval URI) of the subscription data. In certain implementations, the target address contains an external subscriber identifier of the UE.

The processor 605 retrieves first subscription data from the subscription owner using the at least one subscription retrieval parameter and creates second subscription data using the first subscription data. In some implementations, the creating of the second subscription data (in UDM/UDR) is based on the retrieved first subscription data and on a service agreement with the subscription owner.

The processor 605 generates a new subscription identifier (e.g., UE-SI or Group-SI) associated with the second subscription data. In some implementations, the new subscription identifier comprises one of: a group identifier corresponding to a class of subscribers and an individual subscriber identifier.

In some implementations, the processor 605 further initiates a validity timer (e.g., the Cache time, discussed above) for the second subscription data. In one implementation, the processor 605 deletes the second subscription data in response to expiration of the validity timer. In another implementation, the processor 605 updates the second subscription data in response to expiration of the validity timer.

The processor 605 transmits, via the network interface 640, a response to the network function. Here, the response comprising the second subscription data and the new subscription identifier.

In various implementations, the processor 605 controls the NE 600 to implement the above described AMF behaviors. In some implementations, via the network interface 640 the processor 605 receives a registration request message from a UE. Here, the registration request message contains an external subscriber identifier of the UE (e.g., UE-ID).

Via the network interface 640 the processor 605 receives a subscription retrieval information (e.g., Group-SI, Access Token, or Subscription Retrieval URI from AAA server; or UE-SI from UDM). Here, the subscription retrieval information is different than the UE identifier. In some implementations, the subscription retrieval information comprises at least one subscription retrieval parameter which is included in the first request.

In some implementations, the at least one subscription retrieval parameter comprises a credential to access external subscription data (e.g., Access token), the credential provided to the network function by the subscription owner. In some implementations, the at least one subscription retrieval parameter comprises a target address (e.g., Subscription Retrieval URI) of the subscription data. In certain implementations, the target address comprises a UE identifier. In some implementations, the subscription retrieval parameter comprises a group subscription identifier corresponding to a class of subscribers.

In some implementations, receiving the subscription retrieval information comprises receiving subscription retrieval information from an authentication server (AAA server) of the subscription owner. In certain implementations, receiving the subscription retrieval information further comprises receiving an individual subscription identifier from a subscriber data management function (UDM) in the mobile communication network.

Via the network interface 640 the processor 605 transmits to a network function (to UDM/UDR) in the mobile communication network a first request for subscription data retrieval using the subscription retrieval information, wherein the subscription retrieval information indicates that the subscription data is stored in a subscription owner outside the mobile communication network. Via the network interface 640 the processor 605 receives a response message from the network function (from UDM/UDR) that contains the UE subscription data.

In certain implementations, the processor transmits the subscription identifier (along with the UE identifier) to other network functions (e.g., SMF, PCF, etc.) to be used for subscription retrieval (e.g., from the UDM/UDR) within the serving network. In certain implementations, the processor uses the UE identifier (external subscriber identifier) for security operations (e.g., deriving the NAS and AS keys, re-authentication with the subscription owner, exchange signaling with eAUSF, etc.).

In some implementations, the processor uses the subscription retrieval information as a subscription identifier in the UDM/UDR (e.g., UE-SI, Group-SI) to identify the subscription for transactions within a serving network (in the UDM/UDR). In such implementations, the UE identifier is used to identify the subscription for transactions outside the serving network.

The memory 610, in one implementation, is a computer readable storage medium. In some implementations, the memory 610 includes volatile computer storage media. For example, the memory 610 may include a RAM, including dynamic RAM (“DRAM”), synchronous dynamic RAM (“SDRAM”), and/or static RAM (“SRAM”). In some implementations, the memory 610 includes non-volatile computer storage media. For example, the memory 610 may include a hard disk drive, a flash memory, or any other suitable non-volatile computer storage device. In some implementations, the memory 610 includes both volatile and non-volatile computer storage media. In some implementations, the memory 610 stores data relating to registering with a mobile network through another mobile network, for example storing security contexts, IP addresses, UE contexts, and the like. In certain implementations, the memory 610 also stores program code and related data, such as an operating system (“OS”) or other controller algorithms operating on the NE 600 and one or more software applications.

The input device 615, in one implementation, may include any known computer input device including a touch panel, a button, a keyboard, a stylus, a microphone, or the like. In some implementations, the input device 615 may be integrated with the output device 620, for example, as a touchscreen or similar touch-sensitive display. In some implementations, the input device 615 includes a touchscreen such that text may be input using a virtual keyboard displayed on the touchscreen and/or by handwriting on the touchscreen. In some implementations, the input device 615 includes two or more different devices, such as a keyboard and a touch panel.

The output device 620, in one implementation, may include any known electronically controllable display or display device. The output device 620 may be designed to output visual, audible, and/or haptic signals. In some implementations, the output device 620 includes an electronic display capable of outputting visual data to a user. For example, the output device 620 may include, but is not limited to, an LCD display, an LED display, an OLED display, a projector, or similar display device capable of outputting images, text, or the like to a user. As another, non-limiting, example, the output device 620 may include a wearable display such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain implementations, the output device 620 includes one or more speakers for producing sound. For example, the output device 620 may produce an audible alert or notification (e.g., a beep or chime). In some implementations, the output device 620 includes one or more haptic devices for producing vibrations, motion, or other haptic feedback. In some implementations, all or portions of the output device 620 may be integrated with the input device 615. For example, the input device 615 and output device 620 may form a touchscreen or similar touch-sensitive display. In other implementations, all or portions of the output device 620 may be located near the input device 615.

As discussed above, the transceiver 625 may communicate with one or more remote units and/or with one or more interworking functions that provide access to one or more PLMNs. The transceiver 625 may also communicate with one or more network functions (e.g., in the mobile core network 130). The transceiver 625 operates under the control of the processor 605 to transmit messages, data, and other signals and also to receive messages, data, and other signals. For example, the processor 605 may selectively activate the transceiver (or portions thereof) at particular times in order to send and receive messages.

The transceiver 625 may include one or more transmitters 630 and one or more receivers 635. In certain implementations, the one or more transmitters 630 and/or the one or more receivers 635 may share transceiver hardware and/or circuitry. For example, the one or more transmitters 630 and/or the one or more receivers 635 may share antenna(s), antenna tuner(s), amplifier(s), filter(s), oscillator(s), mixer(s), modulator/demodulator(s), power supply, and the like. In one implementation, the transceiver 625 implements multiple logical transceivers using different communication protocols or protocol stacks, while using common physical hardware.

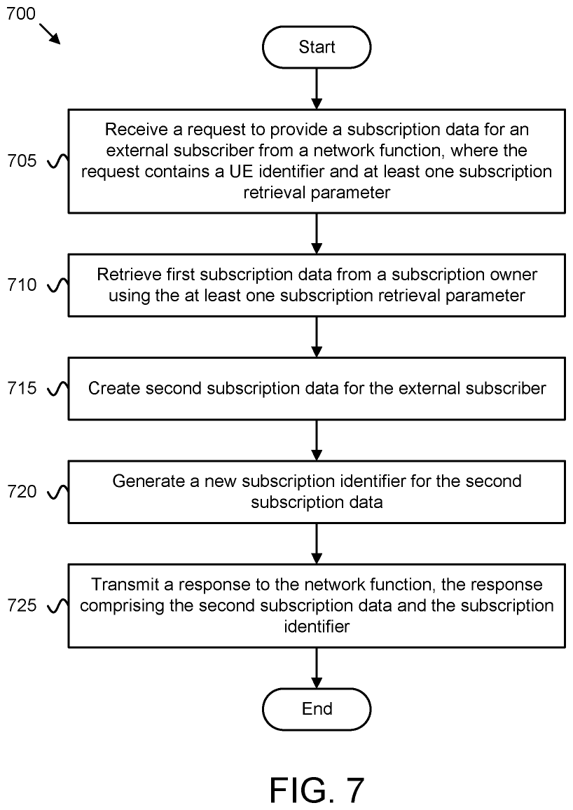

FIG. 7 depicts one implementation of a method 700 for providing subscription data for an external subscriber, in accordance with aspects of the present disclosure. In various implementations, the method 700 is performed by a subscription and user data manager in a mobile communication network, such as the UDM/UDR 129, the UDM/UDR 219, and/or the NE 600, described above. In some implementations, the method 700 is performed by a processor, such as a microcontroller, a microprocessor, a CPU, a GPU, an auxiliary processing unit, a FPGA, or the like.

The method 700 begins and receives 705 a request to provide a subscription data for an external subscriber from a network function in a mobile communication network. Here, the request contains at least one subscription retrieval parameter the at least one subscription retrieval parameter indicates that the subscription data is stored in a subscription owner outside the mobile communication network. The method 700 includes retrieving 710 first subscription data from a subscription owner using the at least one subscription retrieval parameter. The method 700 includes creating 715 second subscription data using the first subscription data. The method 700 includes generating 720 a new subscription identifier associated with the second subscription data. The method 700 includes transmitting 725 a response to the network function, the response comprising the second subscription data and the subscription identifier. The method 700 ends.

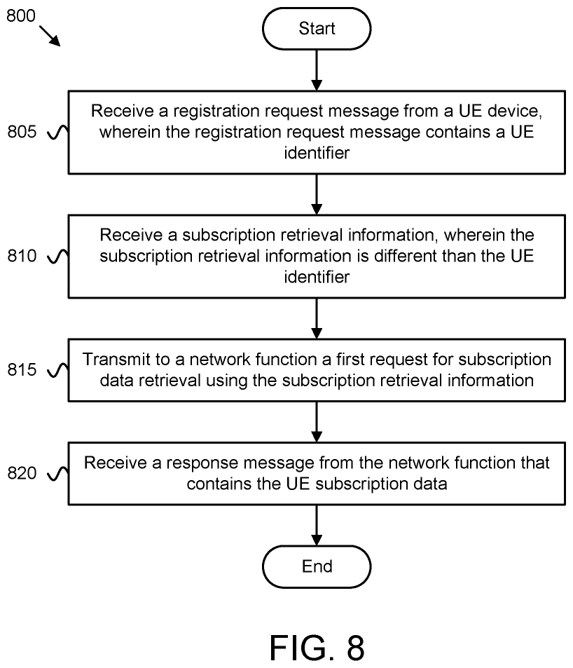

FIG. 8 depicts one implementation of a method 800 for providing subscription data for an external subscriber, in accordance with aspects of the present disclosure. In various implementations, the method 800 is performed by an AMF in a mobile communication network, such as the AMF 123, the AMF 213, and/or the NE 600, described above. In some implementations, the method 800 is performed by a processor, such as a microcontroller, a microprocessor, a CPU, a GPU, an auxiliary processing unit, a FPGA, or the like.

The method 800 begins and receives 805 a registration request message from a UE, wherein the registration request message contains an external subscriber identifier of the UE. The method 800 includes receiving 810 a subscription retrieval information, wherein the subscription retrieval information is different than the external identifier of the UE. The method 800 includes transmitting 815 to a network function a first request for subscription data retrieval using the subscription retrieval information, wherein the subscription retrieval information indicates that the subscription data is stored in a subscription owner outside the mobile communication network. The method 800 includes receiving 820 a response message from the network function that contains the UE subscription data. The method 800 ends.

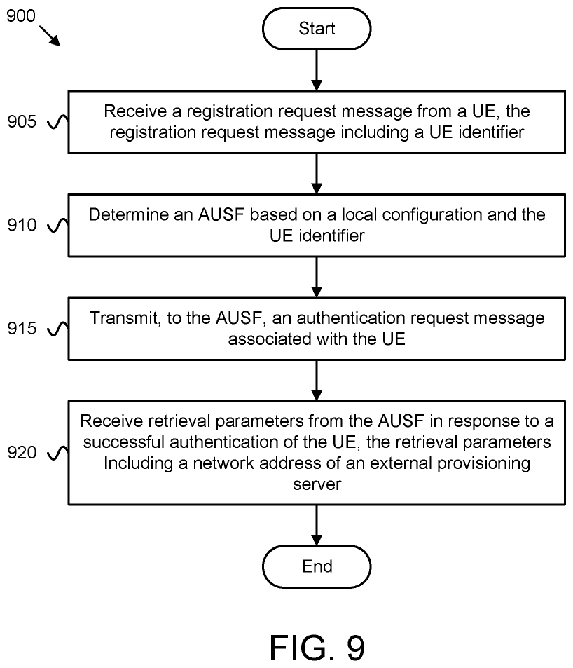

FIG. 9 depicts one implementation of a method 900 for providing subscription data for an external subscriber, in accordance with aspects of the present disclosure. In various implementations, the method 900 is performed by an AMF in a mobile communication network, such as the AMF 123, the AMF 213, and/or the NE 600, described above. In some implementations, the method 900 is performed by a processor, such as a microcontroller, a microprocessor, a CPU, a GPU, an auxiliary processing unit, a FPGA, or the like.

The method 900 begins and receives 905 a registration request message from a UE, the registration request message including a UE identifier. The method 900 includes determining 910 an AUSF based on a local configuration and the UE identifier. The method 900 includes transmitting 915, to the AUSF, an authentication request message associated with the UE. The method 900 includes receiving 920 retrieval parameters from the AUSF in response to a successful authentication of the UE, the retrieval parameters including a network address of an external provisioning server. The method 900 ends.

Disclosed herein is a first apparatus for providing subscription data for an external subscriber, in accordance with aspects of the present disclosure. The first apparatus may be implemented by a subscription and user data manager in a mobile communication network, such as the UDM/UDR 129, the UDM/UDR 219, and/or the NE 600. The first apparatus includes a processor and a network interface that receives, from a network function in the mobile communication network (e.g., from AMF), a request to provide a subscription data for a UE. Here, the request contains at least one subscription retrieval parameter (e.g., Access Token and/or Subscription Retrieval URI), wherein the at least one subscription retrieval parameter indicates that the subscription data is stored in a subscription owner outside the mobile communication network. The processor retrieves first subscription data from the subscription owner using the at least one subscription retrieval parameter and creates second subscription data using the first subscription data. The processor generates a new subscription identifier (e.g., UE-SI or Group-SI) associated with the second subscription data and transmits, via the network interface, a response to the network function. Here, the response comprising the second subscription data and the new subscription identifier.

In some implementations, the processor further initiates a validity timer (e.g., the Cache time, discussed above) for the second subscription data. In one implementation, the processor deletes the second subscription data in response to expiration of the validity timer. In another implementation, the processor updates the second subscription data in response to expiration of the validity timer.

In some implementations, the at least one subscription retrieval parameter comprises a credential (e.g., Access token and subscription URI) to be used to retrieve the first subscription data, wherein the credential is provided to the network function by the subscription owner (e.g., AAA server). In some implementations, the at least one subscription retrieval parameter comprises a target address of the subscription data. In certain implementations, the target address contains an external subscriber identifier of the UE.

In some implementations, the new subscription identifier comprises one of: a group identifier corresponding to a class of subscribers and an individual subscriber identifier. In some implementations, the creating of the second subscription data (in UDM/UDR) is based on the received first subscription data and on a service agreement with the subscription owner.

Disclosed herein is a first method for providing subscription data for an external subscriber, in accordance with aspects of the present disclosure. The first method may be performed by a subscription and user data manager in a mobile communication network, such as the UDM/UDR 129, the UDM/UDR 219, and/or the NE 600. The first method includes receiving a request to provide a subscription data for a UE from a network function in the mobile communication network. Here, the request contains at least one subscription retrieval parameter (e.g., Access Token and/or Subscription Retrieval URI), wherein the at least one subscription retrieval parameter indicates that the subscription data is stored in a subscription owner outside the mobile communication network. The first method includes retrieving first subscription data from the subscription owner using the at least one subscription retrieval parameter and creating second subscription data using the first subscription data. The first method includes generating a new subscription identifier associated with the second subscription data and transmitting a response to the network function, the response comprising the second subscription data and the subscription identifier.

In some implementations, the first method further includes initiating a validity timer (e.g., the Cache time, discussed above) for the second subscription data and performing an action in response to expiration of the validity timer. In one implementation, said action comprises deleting the second subscription data. In one implementation, said action comprises updating the second subscription data.

In some implementations, the at least one subscription retrieval parameter comprises a credential (e.g., Access token and subscription URI) to be used to retrieve the first subscription data, wherein the credential is provided to the network function by the subscription owner (e.g., AAA server). In some implementations, the at least one subscription retrieval parameter comprises a target address of the subscription data. In certain implementations, the target address contains an external subscriber identifier of the UE.

In some implementations, the new subscription identifier comprises one of: a group identifier corresponding to a class of subscribers and an individual subscription identifier. In some implementations, the creating of the second subscription data (in UDM /UDR) is based on the received first subscription data and on a service agreement with the subscription owner.

Disclosed herein is a second apparatus for providing subscription data for an external subscriber, in accordance with aspects of the present disclosure. The second apparatus may be implemented by an AMF in a mobile communication network, such as the AMF 123, the AMF 213, and/or the NE 600. The second apparatus includes a processor and a network interface that receives a registration request message from a UE and receives a subscription retrieval information (e.g., Group-SI, Access token, or Subscription URI from AAA server; or UE-SI from UDM). Here, the registration request message contains an external subscriber identifier of the UE (e.g., UE-ID), where the subscription retrieval information is different than the UE's external subscriber identifier. The processor transmits to a network function in the mobile communication network (to UDM/UDR) a first request for subscription data retrieval using the subscription retrieval information and receives a response message from the network function (from UDM/UDR) that contains the UE subscription data. Here, the subscription retrieval information indicates that the subscription data is stored in a subscription owner outside the mobile communication network.

In some implementations, the subscription retrieval information comprises at least one subscription retrieval parameter which is included in the first request for subscription data retrieval. In certain implementations, the at least one subscription retrieval parameter comprises a credential to access external subscription data (e.g., Access token), the credential provided to the network function by the subscription owner.

In some implementations, the at least one subscription retrieval parameter comprises a target address of the subscription data. In certain implementations, the target address comprises the UE's external subscriber identifier. In some implementations, the subscription retrieval parameter comprises a group subscription identifier corresponding to a class of subscribers.

In some implementations, receiving the subscription retrieval information comprises receiving subscription retrieval information from an authentication server (AAA server) of the subscription owner. In certain implementations, receiving the subscription retrieval information further comprises receiving an individual subscription identifier from a subscriber data management function (UDM) in the mobile communication network.

In some implementations, the processor uses the subscription retrieval information as a subscription identifier in the UDM/UDR (e.g., UE-SI, Group-SI) to identify the subscription for transactions within a serving network (in the UDM/UDR). In such implementations, the UE's external subscriber identifier is used to identify the subscription for transactions outside the serving network. In certain implementations, the processor transmits the subscription identifier (along with the UE identifier) to other network functions (e.g., SMF, PCF, etc.) to be used for subscription retrieval (e.g., from the UDM/UDR) within the serving network. In certain implementations, the processor uses the UE's external subscriber identifier for security operations (e.g., deriving the NAS and AS keys, re-authentication with the subscription owner, exchange signaling with eAUSF, etc.).

Disclosed herein is a second method for providing subscription data for an external subscriber, in accordance with aspects of the present disclosure. The second method may be performed by an AMF in a mobile communication network, such as the AMF 123, the AMF 213, and/or the NE 600. The second method includes receiving a registration request message from a UE and receiving subscription retrieval information. Here, the registration request message contains an external subscriber identifier of the UE (e.g., UE-ID), where the subscription retrieval information is different than the UE's external subscriber identifier. The second method includes transmitting to a network function in the mobile communication network (to UDM/UDR) a first request for subscription data retrieval using the subscription retrieval information and receiving a response message from the network function that contains the UE subscription data. Here, the subscription retrieval information indicates that the subscription data is stored in a subscription owner outside the mobile communication network.

In some implementations, the subscription retrieval information comprises at least one subscription retrieval parameter which is included in the first request for subscription data retrieval. In certain implementations, the at least one subscription retrieval parameter comprises a credential to access external subscription data (e.g., Access token), the credential provided to the network function by the subscription owner.

In some implementations, the at least one subscription retrieval parameter comprises a target address of the subscription data. In certain implementations, the target address comprises the UE's external subscriber identifier. In some implementations, the subscription retrieval parameter comprises a group subscription identifier corresponding to a class of subscribers.

In some implementations, receiving the subscription retrieval information comprises receiving subscription retrieval information from an authentication server (AAA server) of the subscription owner. In certain implementations, receiving the subscription retrieval information further comprises receiving an individual subscription identifier from a subscriber data management function (UDM) in the mobile communication network.

In some implementations, the second method includes using the subscription retrieval information as a subscription identifier in the UDM/UDR (e.g., UE-SI, Group-SI) to identify the subscription for transactions within a serving network (in the UDM/UDR). In such implementations, the UE's external subscriber identifier is used to identify the subscription for transactions outside the serving network. In certain implementations, the second method includes transmitting the subscription identifier (along with the UE identifier) to other network functions (e.g., SMF, PCF, etc.) to be used for subscription retrieval (e.g., from the UDM/UDR) within the serving network. In certain implementations, the second method includes using the UE's external subscriber identifier for security operations (e.g., deriving the NAS and AS keys, re-authentication with the subscription owner, exchange signaling with eAUSF, etc.).

Disclosed herein is a third apparatus, in accordance with aspects of the present disclosure. The third apparatus may implement or be implemented by an AMF in a mobile communication network, such as the AMF 123, the AMF 213, and/or the NE 600. The third apparatus includes at least one processor coupled with at least one memory and configured to cause the AMF to: receive, from a UE, a registration request message containing a UE identifier; determine an AUSF based on a local configuration and the UE identifier; transmit, to the AUSF, an authentication request message associated with the UE; and receive, from the AUSF, retrieval parameters in response to a successful authentication of the UE, where the retrieval parameters include a network address of an external provisioning server.

In some implementations, the AMF is configured to transmit the network address of the external provisioning server to a SMF. In some implementations, the retrieval parameters include an access credential to access external subscription data, the access credential provided by a subscription owner. In some implementations, the retrieval parameters include a subscriber identifier associated with the UE.

In some implementations, the AMF is configured to retrieve subscription data for the UE based on the retrieval parameters. In further implementations, to retrieve the subscription data, the AMF is configured to: A) transmit a request message to a unified data management entity (e.g., UDM/UDR 129, UDM/UDR 139, and/or UDM/UDR 219); and B) receive a response message that contains access management subscription data for the UE.

In some implementations, the UE identifier includes an external subscriber identifier, and the AMF is configured to: A) determine, based at least in part on the external subscriber identifier, that subscription data associated the UE is stored in a subscription owner outside a mobile communication network to which the AMF belongs; and B) trigger UE authentication with the subscription owner in response to the registration request message.

Disclosed herein is a third method, in accordance with aspects of the present disclosure. The third method may be performed by an AMF in a mobile communication network, such as the AMF 123, the AMF 213, and/or the NE 600. The third method includes receiving, from a UE, a registration request message containing a UE identifier; determining an AUSF based on a local configuration and the UE identifier; transmitting, to the AUSF, an authentication request message associated with the UE; and receiving, from the AUSF, retrieval parameters in response to a successful authentication of the UE, where the retrieval parameters include a network address of an external provisioning server.

In some implementations, the third method further includes transmit the network address of the external provisioning server to a SMF. In some implementations, the retrieval parameters include an access credential to access external subscription data, the access credential provided by a subscription owner. In some implementations, the retrieval parameters include a subscriber identifier associated with the UE.

In some implementations, the third method further includes retrieving subscription data for the UE based on the retrieval parameters. In further implementations, retrieving the subscription data includes transmitting a request message to a unified data management entity (e.g., UDM/UDR 129, UDM/UDR 139, and/or UDM/UDR 219) and receiving a response message that contains access management subscription data for the UE.

In some implementations, the UE identifier includes an external subscriber identifier, and the third method further includes: A) determining, based at least in part on the external subscriber identifier, that subscription data associated the UE is stored in a subscription owner outside a mobile communication network including the AMF; and B) triggering UE authentication with the subscription owner in response to the registration request message.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus providing an access and mobility management function (AMF), comprising:
at least one memory; and
at least one processor coupled with the at least one memory and configured to cause the AMF to:
receive, from a user equipment (UE), a registration request message comprising a UE identifier;
determine an authentication server function (AUSF) based on a local configuration and the UE identifier;
transmit, to the AUSF, an authentication request message associated with the UE; and
receive, from the AUSF, retrieval parameters in response to a successful authentication of the UE, wherein the retrieval parameters comprise a network address of an external provisioning server.

2. The apparatus of claim 1, wherein the at least one processor is configured to cause the AMF to transmit the network address of the external provisioning server to a session management function (SMF).

3. The apparatus of claim 1, wherein the retrieval parameters comprise an access credential to access external subscription data, the access credential provided by a subscription owner.

4. The apparatus of claim 1, wherein the retrieval parameters comprise a subscriber identifier associated with the UE.

5. The apparatus of claim 1, wherein the at least one processor is further configured to cause the AMF to retrieve subscription data for the UE based on the retrieval parameters.

6. The apparatus of claim 5, wherein, to retrieve the subscription data, the at least one processor is configured to cause the AMF to:
transmit a request message to a unified data management entity; and
receive, from the unified data management entity, a response message that contains access management subscription data for the UE.

7. The apparatus of claim 1, wherein the UE identifier comprises an external subscriber identifier, and wherein the at least one processor is configured to cause the AMF to:
determine, based at least in part on the external subscriber identifier, that subscription data associated the UE is stored in a subscription owner outside a mobile communication network comprising the AMF; and
trigger UE authentication with the subscription owner in response to the registration request message.

8. A method performed by an access and mobility management function (AMF), the method comprising:
receiving, from a user equipment (UE), a registration request message comprising a UE identifier;
determining an authentication server function (AUSF) based on a local configuration and the UE identifier;
transmitting, to the AUSF, an authentication request message associated with the UE; and
receiving, from the AUSF, retrieval parameters in response to a successful authentication of the UE, wherein the retrieval parameters comprise a network address of an external provisioning server.

9. The method of claim 8, further comprising transmitting the network address of the external provisioning server to a session management function (SMF).

10. The method of claim 8, wherein the retrieval parameters comprise an access credential to access external subscription data, the access credential provided by a subscription owner.

11. The method of claim 8, wherein the retrieval parameters comprise a subscriber identifier associated with the UE.

12. The method of claim 8, further comprising retrieving subscription data for the UE based on the retrieval parameters.

13. The method of claim 12, wherein retrieving the subscription data comprises:
transmitting a request message to a unified data management entity; and
receiving, from the unified data management entity, a response message that contains access management subscription data for the UE.

14. The method of claim 8, wherein the UE identifier comprises an external subscriber identifier, and wherein the method further comprises:
determining, based at least in part on the external subscriber identifier, that subscription data associated the UE is stored in a subscription owner outside a mobile communication network comprising the AMF; and
triggering UE authentication with the subscription owner in response to the registration request message.

15. A processor for wireless communication, comprising:
at least one controller coupled with at least one memory and configured to cause the processor to:
receive, from a user equipment (UE), a registration request message comprising a UE identifier;
determine an authentication server function (AUSF) based on a local configuration and the UE identifier;
transmit, to the AUSF, an authentication request message associated with the UE; and
receive, from the AUSF, retrieval parameters in response to a successful authentication of the UE, wherein the retrieval parameters comprise a network address of an external provisioning server.

16. The processor of claim 15, wherein the at least one controller is configured to cause the processor to transmit the network address of the external provisioning server to a session management function (SMF).

17. The processor of claim 15, wherein the retrieval parameters comprise an access credential to access external subscription data, the access credential provided by a subscription owner.

18. The processor of claim 15, wherein the retrieval parameters comprise a subscriber identifier associated with the UE.

19. The processor of claim 15, wherein the at least one controller is further configured to cause the processor to retrieve subscription data for the UE based on the retrieval parameters.

20. The processor of claim 15, wherein the UE identifier comprises an external subscriber identifier, and wherein the at least one controller is configured to cause the processor to:
determine, based at least in part on the external subscriber identifier, that subscription data associated the UE is stored in a subscription owner outside a mobile communication network comprising the processor; and
trigger UE authentication with the subscription owner in response to the registration request message.
